(19) United States
(12) Patent Application Publication
(10) Pub. No.: US 2015/0382362 A1
(43) Pub. Date: Dec. 31, 2015

(54) RESOURCE SPECIFIC INTERFERENCE MITIGATION

(71) Applicant: QUALCOMM Incorporated, San Diego, CA (US)

(72) Inventors: Cheol Hee Park, San Diego, CA (US); Alexei Yurievitch Gorokhov, San Diego, CA (US); Reza Shahidi, San Diego, CA (US); Amit Mahajan, San Diego, CA (US); Levent Aydin, San Diego, CA (US); Francis Ming-Meng Ngai, Louisville, CO (US)

(21) Appl. No.: 14/319,509

(22) Filed: Jun. 30, 2014

(51) Int. Cl. H04W 72/08

(52) U.S. Cl. CPC H04W 72/082

(57) ABSTRACT

Methods, systems, and devices are described for identifying and mitigating in-device coexistence interference for multicarrier systems implementing soft combining decoding techniques. In some aspects, the described techniques include identifying time-frequency resources of a received signal subject to coexistence interference at a transceiver of a wireless device. The time-frequency resources may include, for example, symbols, slots, code-blocks, sub-frames, subcarriers, etc. Resource-specific mitigation may then be applied to the identified resources, for example, including skipping or nulling the interfered resources in the time domain, frequency domain, or both. In some aspects, the resource-specific mitigation may be performed at the soft-combining stage of the decoding process, such as by skipping or nulling one or more log likelihood ratio (LLR) instances that correspond to the interfered resource(s).

### BACKGROUND

The following relates generally to wireless communication, and more specifically to mobile stations or user equipments (UEs) implementing multiple radio access technologies. Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations, each simultaneously supporting communication for multiple mobile devices. Base stations may communicate with mobile devices on downstream and upstream links. Each base station has a coverage range, which may be referred to as the coverage area of the cell.

Current UEs may implement multiple radio access technologies together, e.g., Long Term Evolution (LTE), Global System for Mobile Communications (GSM), Wideband Code Division Multiple Access (WCDMA), Bluetooth, Wireless Local Area Network (WLAN) technologies such as Wi-Fi, etc. For example, some devices can support concurrent operation on multiple cellular networks by using multiple radio frequency (RF) transceivers. When multiple transceivers are used simultaneously in a mobile device, the device may suffer from interference caused by proximity of multiple RF chains (e.g., in-device coexistence interference). In general, in-device coexistence interference can be caused by various RF nonlinearities, harmonics, intermodulation distortion (IMD), power amplifier (PA) thermal noise or Receiver band noise (RxBN), local oscillator (LO) phase noise, and/or interference coupling between two transceivers. This interference can degrade the receiver performance and cause failure in reception or decoding of desired signals.

For OFDMA systems, this type of interference can affect received signals in the frequency domain (e.g., subcarriers, sub-bands, etc.) or the time domain (e.g., symbol, slot, sub-frame, etc.), or both. Additionally, strong interference on received signals can affect accumulated or soft-combining decoding techniques such as hybrid automatic repeat request (HARQ), where forward error correction coding and retransmission are combined. This interference may be realized in HARQ as incorrect log likelihood ratio (LLR) instances or values in the soft combining process. If some transmissions or retransmissions are affected by strong interference signals, the final combining procedure can fail due to the interfered transmission.

### SUMMARY

The described features generally relate to one or more improved systems, methods, and/or apparatuses for mitigating in-device coexistence interference for multicarrier systems implementing soft combining decoding techniques. In some aspects, the described techniques include identifying time-frequency resources of a received signal subject to coexistence interference at a transceiver of a wireless device, such as a UE or in some cases a base station or eNodeB (eNB). The time-frequency resources may include, for example, symbols, slots, code-blocks, sub-frames, subcarriers, and the like. Identifying the time-frequency resources may include obtaining transmission information from another transceiver causing the coexistence interference, by way of a coexistence manager or the like. Resource-specific mitigation may then be applied to the identified resources. Applying resource specific mitigation may include skipping or nulling the interfered resources in the time domain, or frequency domain, or both. In some cases, nulling may include replacing values of each interfered symbol, for example, with a default value (e.g., zeros) for decoding. In some aspects, the resource-specific mitigation may be performed at the soft-combining stage of the decoding process, such as by skipping, nulling, etc., one or more log likelihood ratio (LLR) instances that correspond to the interfered resource(s). In one example, subframes or code-blocks may be skipped in the soft-combining procedure and the corresponding transmission may be negatively acknowledged in the HARQ process.

Some examples of the present disclosure describe a method for wireless communication including receiving a signal via a first transceiver of a wireless device comprising multiple transceivers, identifying interfered time-frequency resources, the interfered time-frequency resources being time-frequency resources of the received signal subject to coexistence interference, and applying a resource-specific mitigation action for the received signal during a decoding operation of the received signal based at least in part on the interfered time-frequency resources.

Some examples of the present disclosure describe an apparatus for wireless communication, including means for receiving a signal via a first transceiver of a wireless device comprising multiple transceivers, means for identifying interfered time-frequency resources, the interfered time-frequency resources being time-frequency resources of the received signal subject to coexistence interference, and means for applying a resource-specific mitigation action for the received signal during a decoding operation of the received signal based at least in part on the interfered time-frequency resources.

Some examples of the present disclosure describe a wireless communications device, including a memory and at least one processor coupled to the memory, and configured to receive a signal via a first transceiver of a wireless device comprising multiple transceivers, identify interfered time-frequency resources, the interfered time-frequency resources being time-frequency resources of the received signal subject to coexistence interference, and apply a resource-specific mitigation action for the received signal during a decoding operation of the received signal based at least in part on the interfered time-frequency resources.

Some examples of the present disclosure describe a computer program product operable on a wireless communications device, stored on a non-transitory computer-readable medium, and including instructions executable by a processor to receive a signal via a first transceiver of a wireless device comprising multiple transceivers, identify interfered time-frequency resources, the interfered time-frequency resources being time-frequency resources of the received signal subject to coexistence interference, and apply a resource-specific mitigation action for the received signal during a decoding operation of the received signal based at least in part on the interfered time-frequency resources.

In some examples of the methods, apparatuses, devices, and/or computer program products described above applying the resource-specific mitigation action includes nulling samples of the received signal for at least a portion of a symbol period, a slot, a subframe, a code block, or a sub-carrier of the received signal, and inputting the nulled samples into the decoding operation. Nulling the received symbols of the received signal may include setting the received symbols to a default value.

In some examples of the methods, apparatuses, devices, and/or computer program products described above applying the resource-specific mitigation action includes skipping the decoding operation for samples of the received signal for at least a portion of a symbol period, a slot, a subframe, a code block, or a sub-carrier of the received signal.

In some examples of the methods, apparatuses, devices, and/or computer program products described above the interfered time-frequency resources are associated with a transmission from among a plurality of transmissions, wherein the plurality of transmissions are associated with a code block. Applying the resource-specific mitigation action may include skipping decoding of the transmission during the decoding operation. Additionally or alternatively, applying the resource-specific mitigation action may include skipping or nulling at least one log likelihood ratio (LLR) instance corresponding to a decoded output of the transmission during the decoding operation.

Some examples of the methods, apparatuses, devices and/or computer program products described above may include soft combining a plurality of sets of LLR instances from the plurality of transmissions during the decoding operation. In some examples, determining the at least one skipped or nulled LLR instance may be based on the interfered time-frequency resources.

In some examples of the methods, apparatuses, devices, and/or computer program products described above the first transceiver is associated with a first radio access technology, and the coexistence interference originates from a second transceiver associated with a second radio access technology of the multiple transceivers.

In some examples of the methods, apparatuses, devices, and/or computer program products described above identifying the interfered time-frequency resources includes receiving information associated with active transmissions or receptions from the second transceiver and determining a resource conflict for the interfered time-frequency resources based at least in part on the received information.

In some examples of the methods, apparatuses, devices, and/or computer program products described above identifying the interfered time-frequency resources includes obtaining a first power level of a first cell specific reference (CRS) signal associated with the received signal and a second power level of a second CRS signal associated with the received signal, comparing the first power level and the second power level, and determining the interfered time-frequency resources based on the comparison of the first power level and the second power level.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system in accordance with various embodiments;

FIG. 2 shows a block diagram of an exemplary wireless communications system that includes a UE concurrently communicating with another UE and a base station in accordance with various embodiments;

FIG. 3 shows a block diagram of an example of coexistence interference between two different radio access technologies in accordance with various embodiments;

FIG. 4 shows a block diagram of a component carrier subject to coexistence interference in accordance with various embodiments;

FIG. 5 shows a block diagram of an example of an in-device coexistence manager in accordance with various embodiments;

FIGS. 6A and 6B, show flow block diagrams illustrating embodiments of methods for applying resource-specific interference mitigation to identified time-frequency resources subject to in-device coexistence interference in accordance with various embodiments;

FIG. 7 shows a block diagram illustrating a device for applying resource-specific interference mitigation to identified time-frequency resources subject to in-device coexistence interference in accordance with various embodiments;

FIG. 8 shows a block diagram illustrating another device for applying resource-specific interference mitigation to identified time-frequency resources subject to in-device coexistence interference in accordance with various embodiments;

FIG. 9 shows a block diagram illustrating another device for applying resource-specific interference mitigation to identified time-frequency resources subject to in-device coexistence interference in accordance with various embodiments;

FIG. 10 shows a block diagram of an example of a MIMO wireless communication system in accordance with various embodiments; and

FIGS. 11-13 illustrate flowcharts of methods for applying resource-specific interference mitigation to identified time-frequency resources subject to in-device coexistence interference in accordance with various embodiments.

### DETAILED DESCRIPTION

The described features generally relate to one or more improved systems, methods, and/or apparatuses for mitigating in-device coexistence interference for devices operating in multicarrier systems. In some aspects, the described techniques include identifying time-frequency resources of a received signal subject to coexistence interference at a wireless device implementing multiple transceivers. In one example, the wireless device may gather or obtain transmission/reception information from disparate radios implemented on the device, for example from each transceiver, and determine if in-device coexistence interference is likely to occur to specific time-frequency resources of a received signal. The transmission/reception information may include transmission/reception timing information (e.g., relative to one or more clocks), frequency information, power information (e.g., power amplification, etc.), and/or other similar information. The device may detect time and/or frequency overlap or conflicts between operations to be performed by the multiple transceivers based on known or detected interference mechanisms (e.g., harmonics, IMD, thermal noise, RxBN, etc.).

The wireless device may then apply resource-specific mitigation to the identified resources. In some aspects, applying resource specific mitigation may include skipping or nulling the interfered resources in the time domain (e.g., symbols, slots, code-blocks, sub-frames, etc.), frequency domain (e.g., subcarriers, etc.), or both. The granularity at which resource specific interference is mitigated may impact communication performance, for example with sub-carrier and symbol level mitigation yielding the most accurate interference cancelation. In some cases, nulling may include replacing values of each interfered symbol, for example, with a default value (e.g., zeros) for decoding.

In some aspects, applying resource-specific mitigation may be performed at the soft-combining stage of the decoding process. The resource-specific mitigation may include skipping, nulling, or suppressing interfered decoding outputs (e.g., LLR values or instances) from being included in the soft combining procedure. By preventing interference propagation (e.g., suppressing the interfered decoding outputs such as LLRs from being added back into the soft combining), combining/decoding failures due to propagated in-device coexistence interference can be mitigated and/or eliminated. In one example, LLRs may be skipped or discarded in the soft-combining procedure and the corresponding transmission may be negatively acknowledged in the HARQ process. Applying these techniques may reduce the block error rate (BLER) and result in a higher overall data throughput. The described techniques may be performed by a mobile device, or in some cases a base station or access point.

Techniques described herein may be used for various wireless communications systems such as CDMA, TDMA, FDMA, OFDMA, SC-FDMA, SC-TDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

Thus, the following description provides examples, and is not limiting of the scope, applicability, or configuration set forth in the claims. Changes may be made in the function and arrangement of elements discussed without departing from the scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

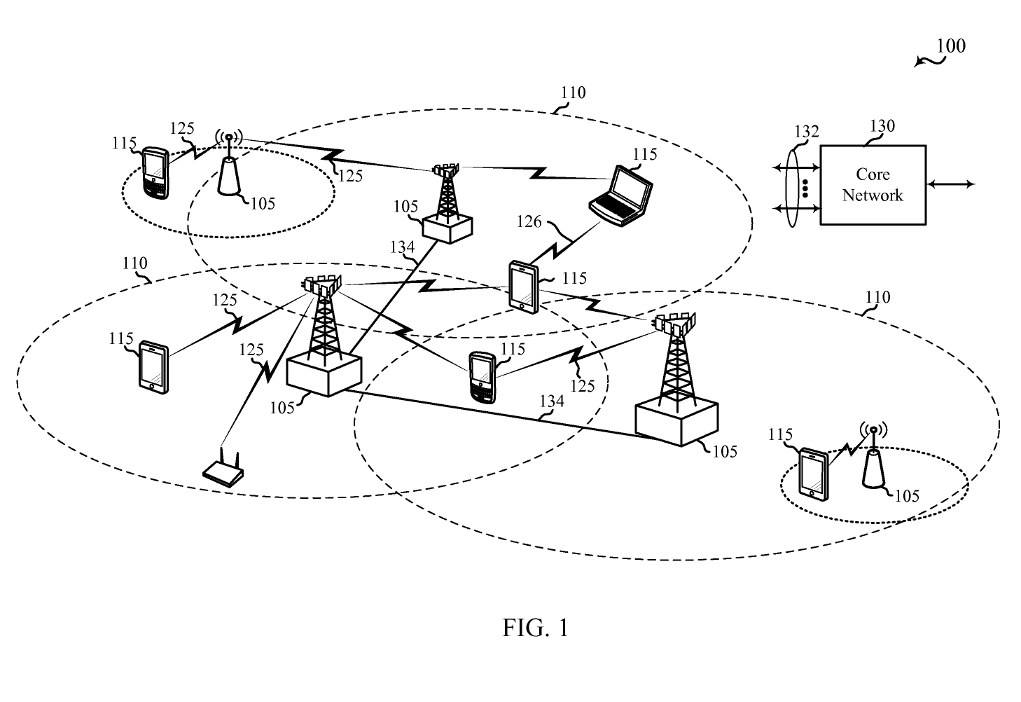

FIG. 1 illustrates an example of a wireless communication system 100. The wireless communication system 100 includes base stations (or cells) 105, mobile stations or user equipment (UEs) 115, and a core network 130. The base stations 105 may communicate with the UEs 115 under the control of a base station controller (not shown), which may be part of the core network 130 or the base stations 105 in various examples. Base stations 105 may communicate control information and/or user data with the core network 130 through backhaul links 132. In examples, the base stations 105 may communicate, either directly or indirectly, with each other over backhaul links 134, which may be wired or wireless communication links. The wireless communication system 100 may support operation on multiple carriers (waveform signals of different frequencies). Multi-carrier transmitters can transmit modulated signals simultaneously on the multiple carriers. For example, each communication link 125 between a base station 105 and a UE 115, and each communication link 126 between two UEs 115, may be a multi-carrier signal modulated according to the various radio technologies described above. Each modulated signal may be sent on a different carrier and may carry control information (e.g., reference signals, control channels, etc.), overhead information, data, etc. Each modulated signal may be sent on a different carrier and may carry control information (e.g., pilot signals, control channels, etc.), overhead information, data, etc. The system 100 may be a multi-carrier LTE network capable of efficiently allocating network resources.

The base stations 105 may wirelessly communicate with the UEs 115 via one or more base station antennas. Each of the base station 105 sites may provide communication coverage for a respective geographic coverage area 110. In some examples, a base station 105 may be referred to as a base transceiver station, a radio base station, an access point, a radio transceiver, a basic service set (BSS), an extended service set (ESS), a NodeB, an eNodeB (eNB), a Home NodeB, a Home eNodeB, or some other suitable terminology. The geographic coverage area 110 for a base station 105 may be divided into sectors making up only a portion of the coverage area (not shown). The system 100 may include base stations 105 of different types (e.g., macro, micro, and/or pico base stations). There may be overlapping coverage areas for different technologies.

In certain examples, the wireless communication system 100 may include an LTE/LTE-A network. The LTE/LTE-A network may be a Heterogeneous LTE/LTE-A network in which different types of eNBs provide coverage for various geographical regions. For example, each base station 105 may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femtocell would also generally cover a relatively small geographic area (e.g., a home) and, in addition to unrestricted access, may also provide restricted access by UEs having an association with the femtocell (e.g., UEs 115 in a closed subscriber group (CSG), UEs 115 for users in the home, and the like). An eNB for a macro cell may be referred to as a macro eNB. An eNB for a pico cell may be referred to as a pico eNB. And, an eNB for a femtocell may be referred to as a femto eNB or a home eNB. An eNB may support one or multiple (e.g., two, three, four, and the like) cells.

The core network 130 may communicate with the base stations 105 via backhaul links 132 (e.g., S1, etc.). The base stations 105 may also communicate with one another, e.g., directly or indirectly via backhaul links 134 (e.g., X2, etc.) and/or via backhaul links 132 (e.g., through core network 130). The wireless communication system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The UEs 115 may be dispersed throughout the wireless communication system 100, and each UE 115 may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE 115 may be able to communicate with macro base stations, pico base stations, femto base stations, relays, and the like.

The communication links 125 shown in the wireless communication system 100 may include uplink transmissions from a UE 115 to a base station 105, and/or downlink transmissions, from a base station 105 to a UE 115. The downlink transmissions may also be called forward link transmissions while the uplink transmissions may also be called reverse link transmissions.

In some scenarios, a UE 115 may communicate concurrently with two or more wireless devices, e.g., two base stations 105, two UEs 115, or a base station 105 and another UE 115, via two or more different radio access technologies. For example, the UE 115 may communicate concurrently via LTE/LTE-A and another radio access technology, such as GSM, Bluetooth, WLAN technologies such as Wi-Fi, etc. Different radio access technologies may generally be allocated different frequency ranges or bands (e.g., licensed or unlicensed spectrum bands). However, even when different frequency ranges are used for different radio access technologies, coexistence interference between two radio access technologies can have a significant impact on performance. In some cases, this interference may negatively impact the user experience via unreliable data connections, dropped calls, slow downloading, etc. In some cases, base stations 105 may also experience similar coexistence interference when employing multiple radio access technologies or multiple frequency bands, resulting in reduced performance for radio links with served UEs 115.

In order to reduce and/or eliminate co-existence interference, a UE 115, and in some cases a base station 105, may implement the described techniques to mitigate coexistence interference. The UE 115 or base station 105 may identify time-frequency resources of a received signal subject to the coexistence interference, for example, by comparing information of the received signal and/or via information communicated from a coexistence manager implemented in the UE 115 itself. The UE 115 may apply a resource-specific mitigation action to the received signal during a decoding operation, such as by nulling or skipping the interfered resource. In this way communication performance of the UE 115 may be improved to better support concurrent communication via two or more radio access technologies.

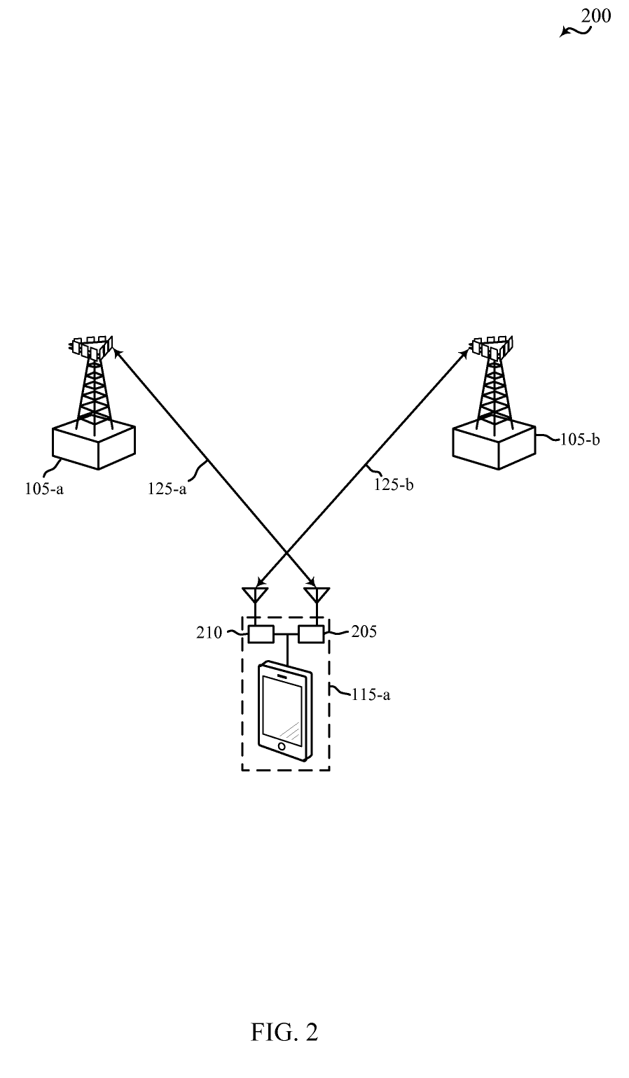

FIG. 2 illustrates an example of a wireless communication system 200 including a UE 115-a in communication with a first base station 105-a over communication link 125-a and second base station 105-b over communication link 125-b. UE 115-a and base stations 105-a, 105-b may be examples of UEs 115 and base stations 105 described in reference to FIG. 1. UE 115-a may include a first transceiver 205 and a second transceiver 210, each configured to communicate using one or more radio access technologies such as LTE/LTE-A, GSM, WCDMA, Bluetooth, Wi-Fi, and the like. In other embodiments, the UE 115-a may communicate with another UE 115 and a base station 105. It should be appreciated that the interference mitigation techniques described below may equally apply to both scenarios. In some cases, UE 115-a may include more than two transceivers, where each transceiver is configured to communicate using one or more of these radio access technologies.

In some examples, UE 115-a may be a multiple subscriber identity module (SIM) multiple active device, and may support separate cellular networks by using multiple SIM cards and separate radio frequency (RF) transceivers 205, 210.

As shown in FIG. 2, UE 115-a may concurrently communicate with base station 105-a over link 125-a via transceiver 205 and with base station 105-b over link 125-b via transceiver 210. In one example, communications over links 125-a and 125-b may utilize different radio access technologies. For example, UE 115-a may communicate with base station 105-a over link 125-a using LTE/LTE-A, while concurrently communicating with base station 105-b over link 125-b using GSM. Various other combinations of radio access technologies may be implemented or supported by transceiver 205, 210 and over links 125-a, 125-b. In some instances, UE 115-a may receive a transmission from base station 105-a over link 125-a at transceiver 205 at the same time transceiver 210 is transmitting to base station 105-b. In this scenario, the UE 115-a may experience in-device coexistence interference on the received signal at transceiver 205 caused by the transmission from transceiver 210. It should be understood that, while in-device coexistence interference for a received signal is more commonly caused by interference from a concurrent transmission, it may potentially be caused by interference effects (e.g., RxBN, IMD, etc.) from various components involved in receiving another transmission at the same time.

The UE 115-a may employ interference mitigation techniques, as described herein, to limit the effect of the interference on the received signal. In particular, the UE 115-a may identify resources (e.g., symbols, slots, code-blocks, sub-frames, subcarriers, etc.) of the received signal subject to the coexistence interference. Identifying the interfered resources may include obtaining transmission or reception information from the other transceiver 210 (e.g., via a coexistence manager, which will be described in greater detail below). Additionally or alternatively, the UE 115-a may identify the interfered resources by comparing the received signal strength of reference symbols, such as cell specific reference symbols (CRSs), in the received transmission. The UE 115-a may then apply a resource-specific mitigation action to the identified interfered resources. The mitigation action may include skipping or nulling time and/or frequency resources during or prior to the decoding process, for example, skipping or nulling symbols, slots, code-blocks, sub-frames, subcarriers.

By mitigating the coexistence interference, the UE 115-a may improve reception performance of the message received from the base station 105-a. In some cases, the UE 115-a may improve the accuracy of the decoding process to eliminate the need for retransmission of the message in the first instance.

In another example, the resource-specific mitigation action may include skipping or nulling LLR instances corresponding to the interfered time-frequency resources as part of a soft combining process of an automatic repeat request (ARQ) or hybrid automatic repeat request (HARQ) procedure. In standard ARQ, redundant bits are added to data to be transmitted using an error-detecting (ED) code such as a cyclic redundancy check (CRC). When a message is received with errors, a request for retransmission of the original transmission may be sent, for example via a negative acknowledgment (NACK) message. In HARQ schemes, the original data is encoded with a forward error correction (FEC) code, and parity bits used for error detection are either immediately sent along with the message or only transmitted upon request when a receiver detects an erroneous message. The FEC code is chosen to correct an expected subset of all errors that may occur, while ARQ techniques are used to correct errors that are uncorrectable using only the redundancy sent in the initial transmission. Some HARQ schemes may include soft combining such that after a received transmission is decoded, log-likelihood ratios (LLRs) may be associated with the decoded transmission indicating the probabilities for interpreting each bit of the decoded transmission (e.g., code block, etc.). The soft combining process may include summing the LLRs of multiple transmissions/retransmissions of the same data or other data providing redundancy information to obtain the complete and error free original transmission. In some cases, the same information including both data and parity bits may be retransmitted after a NACK is sent (e.g., chase combining) In other cases, only some of the information (e.g., redundancy bits), may be sent (e.g., incremental redundancy). In some examples, retransmissions may be associated with a redundancy version to identify how the soft combining procedure should account for different information being retransmitted.

Accordingly, interference-affected transmissions can hurt the whole retransmission and soft combining procedure. If some transmissions/retransmissions are affected by strong interference levels, the final combining procedure may fail due to the interfered transmission even though sufficient interference-free data and/or redundancy information is received. By skipping or nulling LLR instances that correspond to interfered resources, the efficiency and accuracy of the soft combining procedure may be improved, the block error rate (BLER) decreased, and the throughput of the system increased as a result.

In some implementations, for example when the HARQ procedure supports ACK/NACK operation for resource partitions smaller than a transport block, (e.g., code blocks), the UE 115-a may decrease the number of retransmissions required to receive the entire message error free. This may be accomplished by limiting the request for retransmission to only include time-frequency resources that were actually interfered with, for example, by identifying which resources have interference to a higher level of granularity or accuracy. This may result in fewer resources within a close proximity of the interfered resources being included in the identified set of interfered resources.

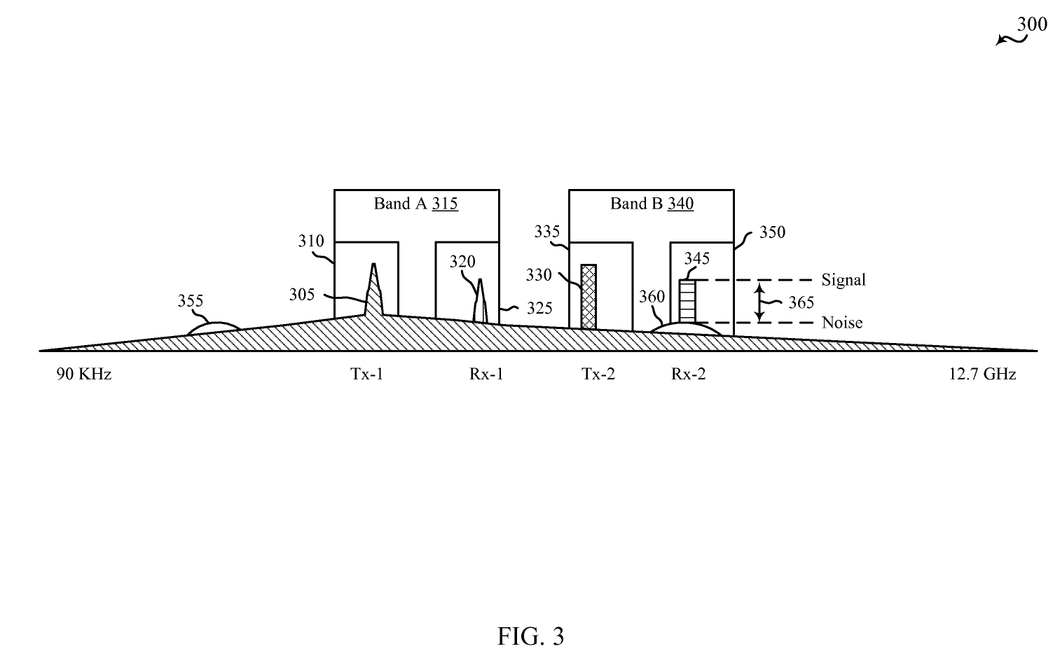

FIG. 3 illustrates a diagram 300 showing an example of interference between two different radio access technologies implemented on the same device, such as a UE 115 or in some cases a base station 105, relative to a frequency spectrum spanning from 90 KHz to 12.7 GHz. In particular, diagram 300 illustrates a transmission event TX-1 305 and a reception event RX-1 320 in Band A 315, and a transmission event TX-2 330 and a reception event RX-2 345 in Band B 340. In some embodiments, Band A 315 may represent a GSM band, and Band B 340 may represent an LTE/LTE-A band; however, it should be appreciated that other radio access technologies/band configurations are contemplated herein. In some embodiments, TX-1 305 and RX-1 320 may represent communications by transceiver 210 of UE 115-a of FIG. 2, for example over communication link 125-b with base station 105-b. Similarly, TX-2 330 and RX-2 345 may represent communications by transceiver 205 also of UE 115-a of FIG. 2, for example over communication link 125-a with base station 105-a. TX-1 305 and RX-1 320 may be within TX sub-band 310 and RX sub-band 325 of Band A 315 in accordance with GSM. Similarly, TX-2 330 and RX-2 345 may be within TX sub-band 335 and RX sub-band 350 of Band B 340 in accordance with LTE/LTE-A.

In one example, the power band of TX-1 305, although the greatest amplitude in TX sub-band 310, may result in spurious effects for other components of the device in other portions of the frequency spectrum. TX-1 305 may, as a result, cause co-existence interference to transceiver 205 communicating over Band B 340, for example at instance 360. Interference instances 355 and 360 may be caused by various RF nonlinearities, harmonics, intermodulation distortion (IM), power amplifier (PA) thermal noise or Rx band noise (RxBN), local oscillator (LO) phase noise, and interference coupling between two transceivers. This interference can degrade the reception performance of another transceiver of UE 115, e.g., an LTE receiver receiving RX-2 345, such as at interference instance 360. The interference may additionally or alternatively cause emission failure, such as at instance 355, by another radio access technology implemented on the UE 115. The in-device coexistence interference can also severely degrade RF and analog circuit-related processing, estimation, tracking, measurement, demodulation, and decoding of signals by UE 115.

Specifically, interference instance 360 may cause the signal to noise ratio (SNR), carrier to noise ratio (CNR), or other similar metric of RX-2 345 to degrade. For example, interference instance 360 may cause a decrease in the CNR 365. This decrease in the CNR 365 of RX-2 345 may cause reception failure such that the UE 115 may request retransmission of the signal using an HARQ process to receive the signal error free. Throughput and overall performance of the LTE/LTE-A communication link of the UE 115 may be decreased as a result. The coexistence interference mitigation techniques described herein may reduce the negative impact on the LTE/LTE-A transceiver of UE 115, for example, by making the decoding and HARQ process more efficient, as will be described in greater detail below.

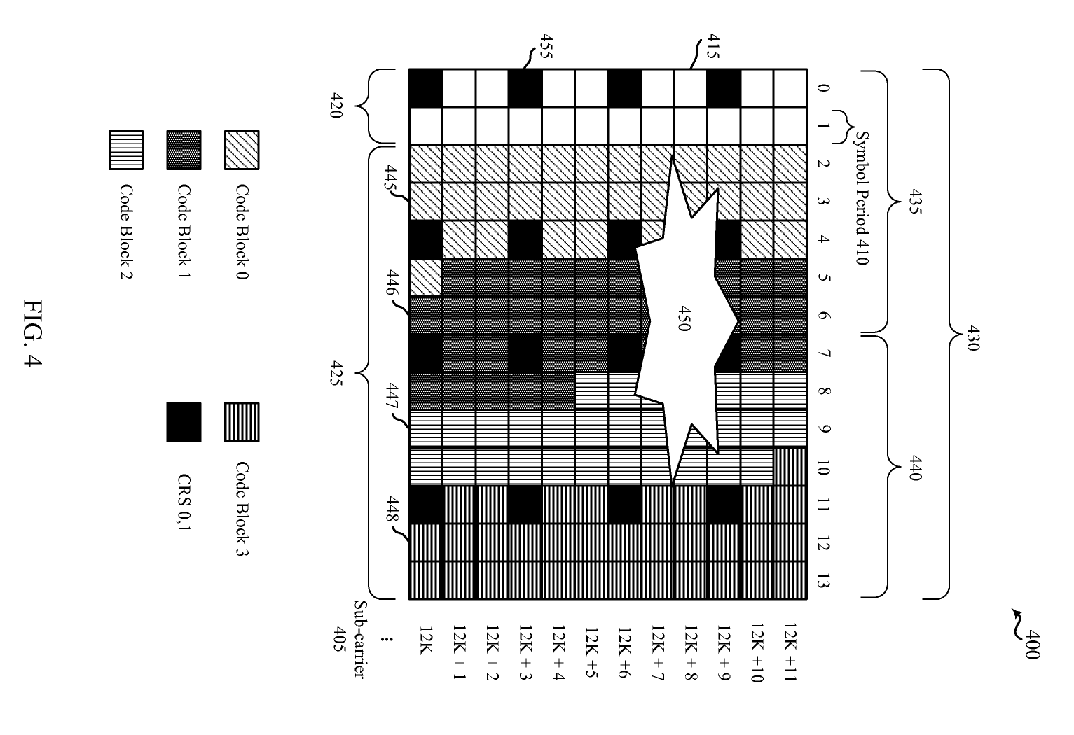

Generally, LTE/LTE-A utilizes orthogonal frequency division multiple-access (OFDMA) on the downlink and single-carrier frequency division multiple-access (SC-FDMA) on the uplink. FIG. 4 illustrates a diagram of time-frequency resources for an OFDMA downlink component carrier 400, with a subset of the time-frequency resources experiencing coexistence interference 450, in accordance with various embodiments. The component carrier 400 may be received by any of UEs 115 described in reference to the previous Figures, for example by transceiver 205 of UE 115-a of FIG. 2. The carrier bandwidth for component carrier 400 may be partitioned into multiple (N) orthogonal subcarriers 405 which are also commonly referred to as tones, bins, or the like. The spacing between adjacent subcarriers 405 may be fixed, and the total number (N) of subcarriers 405 may be dependent on the system bandwidth. Each subcarrier 405 may be modulated with data. One subcarrier over one symbol period 410 may be referred to as a resource element 415 or more generally as a time-frequency resource. The system bandwidth may further be divided into physical resource blocks (PRBs), which may include a number (e.g., 6, 12, etc.) subcarriers. The illustrated portion of component carrier 400 includes the K^{th} physical resource block (PRB), which may include subcarriers 12K through 12K+11 of the carrier bandwidth. Component carrier 400 may have any number (N) of subcarriers. For example, N may be equal to 72, 180, 300, 600, 900, or 1200 with a subcarrier spacing of 15 kilohertz (KHz) for a corresponding system bandwidth (with a guardband) of 1.4, 3, 5, 10, 15, or 20 megahertz (MHz), respectively. The system bandwidth may also be partitioned into sub-bands. For example, a sub-band may cover 1.08 MHz, and there may be 1, 2, 4, 8 or 16 sub-bands. It should be appreciated that the techniques described herein are equally applicable to other implementations of OFDM/OFDMA.

Time-frequency resource elements 415 may be used for different purposes. For example, a set of resource elements, such as symbol periods 0 and 1, may be reserved for transmission associated with a downlink control channel 420, such as physical downlink control channel (PDCCH), a physical hybrid-ARQ indicator channel (PHICH), and/or a physical control format indicator channel (PCFICH). Another set of resource elements may correspond to a physical downlink shared channel (PDSCH) 425, such as symbol periods 2 through 13. PDSCH 425 may be used to transmit user data to one or more UEs 115 described with reference to FIGS. 1, 2, and/or 3 above.

The component carrier 400 may be divided into various partitions of symbol periods 410. For example, sub-frame 430, which may be a portion of a downlink transmission (e.g., 1/10 of a frame), may be approximately 1 ms in length and may include symbol periods 0 through 13. Each subframe 430 may be further subdivided into slots, such as slot 435 including symbols periods 0 through 6, and slot 440 including symbol periods 7 through 13. Each symbol period 410 may cover a length of time sufficient to transmit a single modulation symbol. A symbol period 410 may also include a period of time reserved for a guard period and/or transmission of a cyclic prefix.

The illustrated portion of component carrier 400 shows portions of a transport block transmitted by a base station 105 to a UE 115. The transport block may include multiple code blocks (e.g., if code block segmentation is implemented), such as code blocks 0 445, code block 1 446, code block 2 447, and code block 3 448. Each code block may be assigned different time-frequency resources within the physical resource blocks assigned for transmission of the transport block. For example, code blocks 0-3 may be assigned resources within a set of physical resource blocks in a frequency-first, time-second approach. However, it should be appreciated that other configurations and assignments of time-frequency resources to various transport blocks and/or code blocks are contemplated herein.

As illustrated in FIG. 4, interference 450 may affect some time-frequency resources of component carrier 400, such as symbol periods 2 through 10 transmitted on sub-carriers 12K+6 through 12K+9 to varying degrees. It should be appreciated that interference 450 is shown only as an example, different interference scenarios may affect different time-frequency resources of any given downlink transmission or component carrier.

Once the UE 115 receives component carrier 400, the UE 115 may identify the time-frequency resources affected by the interference 450. In some implementations, a first transceiver (e.g., LTE/LTE-A transceiver 205 of FIG. 2) of UE 115 may obtain interference information associated with a concurrent transmission or reception event from a second transceiver (e.g., transceiver 210 of FIG. 2) also implemented on the UE 115, such as a GSM, Bluetooth, or CDMA transceiver, via a coexistence manager. The coexistence manager may obtain transmission/reception timing information (e.g., relative to one or more clocks), frequency information, power information (e.g., power amplification, etc.), and/or other similar information from both of the transceivers implemented on the UE 115. The coexistence manager may detect time and/or frequency overlap or conflicts between operations to be performed by the multiple transceivers based on known or detected interference mechanisms (e.g., harmonics, IMD, thermal noise, RxBN, etc.). Once the interfered resources 450 have been identified, the coexistence manager may apply interference mitigation to the received signal.

In applying interference mitigation, the UE 115 may compare the registered information of currently active transmissions/receptions and based on the comparison, determine if the described interference mitigation techniques should be enabled. More specifically, interference mitigation may include applying a resource-specific interference mitigation action to identified interfered resources, for example by the coexistence manager itself, or by other means associated with a transceiver of the UE 115. Applying a resource-specific interference mitigation action may include skipping or nulling received samples associated with the interfered resources (e.g., resource elements affected by interference 450) to improve the performance of the decoding procedure. Skipping or nulling the received samples associated with the interfered resources may be performed at different levels of granularity, for example at the sub-frame, symbol period, or subcarrier level, depending on processing and power resources of the UE 115.

In yet another example, the UE 115 may skip or null LLR instances that correspond to the interfered time-frequency resources affected by interference 450 to improve soft combining performance and throughput of the system. In this example, the UE 115 may map interfered resources to LLR instances input into the soft-combining process. This may involve taking into account mapping of specific time-frequency resource subject to interference through receive processing operations (e.g., demodulation, rate-matching, de-interleaving, Fast Fourier Transform (FFT) processing, etc.). Skipping or nulling LLR instances corresponding to interfered resources may minimize or prevent interference propagation such that boosted interfered decoding outputs will not affect the accumulated or combined decoding. In this way, combining/decoding failures due to propagated in-device coexistence interference can be avoided and/or eliminated.

Some time-frequency resource elements 415 within the PDCCH 420 or PDSCH 425 may be used for the transmission of reference signals. Reference signals, such as cell specific reference signals (CRSs) 455, may be used for channel identification and channel quality estimation. One or more CRSs 455 may be included in some symbol periods and subcarriers, and different positions may be associated with different antenna ports. In one example, the UE 115 may compare different properties (e.g., received power) of received CRSs 455 to identify time-frequency resource elements 415 subject to in-device coexistence interference. For example, the CRS 455 at symbol period 0 transmitted over sub-carrier 12K+9 may be at a first received power level, whereas other CRSs 455 associated with the same antenna port (e.g., CRS 455 at symbol period 4 and subcarrier 12K+6, etc.) may be received at a second power level due to interference 450. The UE 115 may compare the received power levels of CRS symbols and determine, based on the comparison (e.g., difference between the received power levels for certain time-frequency resources), that certain sub-carriers, symbol periods, or blocks of time-frequency resource elements 415 are experiencing strong interference potentially caused by in-device coexistence. The UE 115 may then apply resource specific mitigation based on the determination. The resource specific mitigation may include, for example, performing skipping or nulling for samples associated with the interfered time-frequency resources (e.g., all the symbol periods for certain sub-carriers, all sub-carriers for certain symbol period, portions of sub-carriers or symbol periods, all of a slot 435 or 440, or the entire subframe 430). In other cases, more/different CRSs (e.g., CRS symbols associated with different antenna ports, etc.) may be compared to identify the interfered time-frequency resource elements 415 at different levels of granularity (e.g., resource element, symbol period, slot, sub-frame, sub-carrier, etc.). In some embodiments, both the in-device coexistence manager and the CRS techniques may be implemented together.

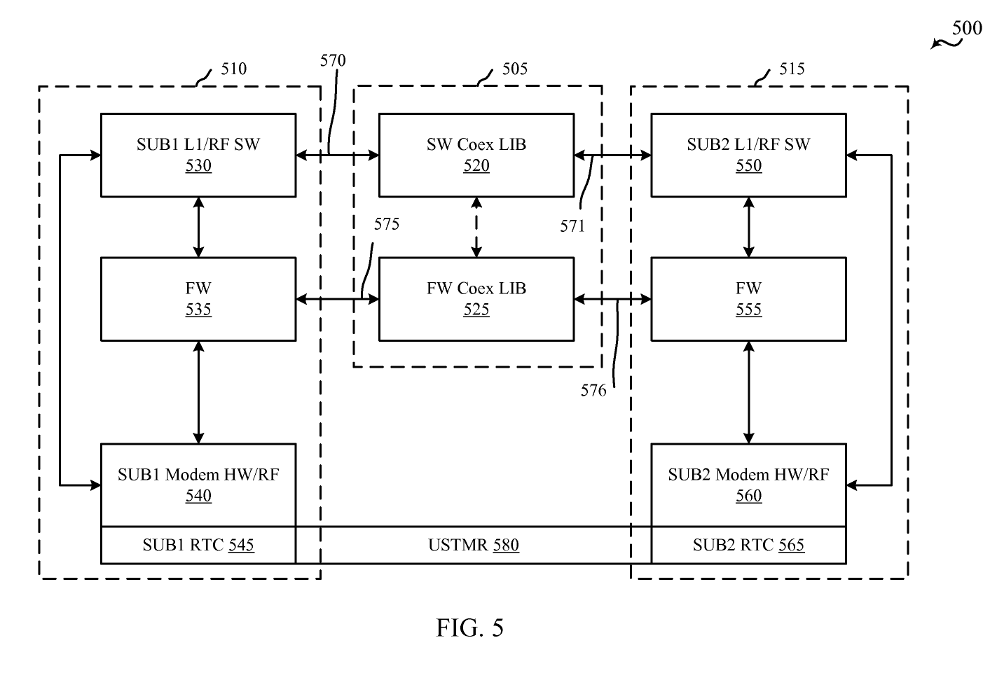

FIG. 5 illustrates a diagram 500 of components of a device for managing in-device coexistence interference, in accordance with various embodiments. Diagram 500 illustrates a coexistence manager 505 in communication with a first transceiver 510 and a second transceiver 515. Coexistence manager 505 may be an example of some or all of the aspects of the coexistence manager described above in reference to the previous Figures. Furthermore, transceivers 510 and 515 may be an example of some or all of the aspects of transceivers 205, 210 described above in reference to FIG. 2. For example, transceiver 510 may support LTE/LTE-A communications, while transceiver 515 may support GSM, Bluetooth, WCDMA, etc., communications, as described above. The coexistence manager 505 may include a software coexistence label information base (SW Coex LIB) 520 in communication with a firmware coexistence label information base (FW Coex LIB) 525. The first transceiver 510 may include an RF software module (SUB1 L1/RF SW) 530, a firmware (FW) module 535, and an RF modem (SUB1 Modem HW/RF) 540 including a real time clock (SUB1 RTC) 550, each of which may be in communication with one another. Similarly, the second transceiver 515 may include an RF software module (SUB2 L1/RF SW) 550, a firmware module (FW) 555, and an RF modem (SUB2 Modem HW/RF) 560 including a real time clock (SUB2 RTC) 565, each of which may be in communication with one another. SUB1 L1/RF SW 530 and SUB2 L1/RF SW 550 may be in communication with the SW Coex LIB 520 at the frame or code block level via links 570, 571. FW 535 and FW 555 may be in communication with FW Coex LIB 525 at the slot level via links 575, 576. SUB1 RTC 545 and SUB2 RTC 565 may align or synchronize via universal synchronized timer USTMR 580.

Each transceiver 510, 515 may communicate transmission/reception timing information (e.g., relative to RTCs 545, 565, and/or USTMR 580), frequency information, power information (e.g., power amplification, etc.), and/or other similar information to the coexistence manager 505. Additionally or alternatively, the coexistence manager 505 may detect time and/or frequency overlap or conflicts between operations to be performed by the multiple transceivers 510, 515. For example, the coexistence manager 505 may detect conflicts in the time domain between transmission/reception operations for transceiver 510 with transmission/reception operations for transceiver 515. For detected conflicts, the coexistence manager 505 may, based on transmission/reception parameters (e.g., frequencies, power, etc.), determine if the transmission/reception operations will cause interference to either transceiver (e.g., using information regarding predetermined interference mechanisms in a lookup table, etc.). In particular, the coexistence manager 505 may determine an effect of a known interference mechanism (e.g., harmonics, IMD, thermal noise, RxBN, etc.) and inform the transceiver 510, 515 of the affected time-frequency resources. The known interference mechanisms can be determined by laboratory tests on the transceiver components or sub-assemblies, or by detecting interference conditions as they occur in operation of the device, in some cases. In some embodiments, the transceiver 510, 515 may apply interference mitigation on the received signal based on the identified time-frequency resource subject to interference. In other embodiments, the coexistence manager 505 may resolve conflicts according to priorities based on communication type (e.g., voice call, data transmission/reception, etc.). Conflict resolution may include band avoidance, blanking or power backoff for transmissions, or interference mitigation for received signals.

In some aspects, each transceiver 510, 515 may register short term transmission and reception activity/information with the FW Coex LIB 525 of the coexistence manager 505 via the FW modules 535, 555. The FW Coex LIB 525 may store the transmission/reception registration information and detect/identify short term conflicts between the two transceivers 510, 515, e.g., identify time-frequency resources subject to in-device coexistence interference. For example, each transceiver 510, 515 may communicate the registration information at the subframe or slot level at 575, 576. Each of the FW module 535, 555 of transceiver 510 and 515 may also query the FW Coex LIB 525 for resource conflicts, for example, that may cause coexistence interference and use this information to apply a resource-specific mitigation action to received transmissions, in accordance with the techniques described above.

In some cases, each FW module 535, 555 may communicate conflict/interference information obtained from the FW Coex LIB 525 to the SUB1 L1/RF SW 530, SUB2 L1/RF SW 550 so that transmission/reception activity may be coordinated between the two transceivers 510, 515. Coordination may help avoid the in-device coexistence interference in the first instance.

In some cases, the SW Coex LIB 520 may provide priority information to the transceivers 510, 515 to help avoid resource conflicts/in-device coexistence interference in the first instance. In some aspects, each transceiver 510, 515 may register long term transmission and reception activity/information with the SW Coex LIB 520 of the coexistence manager 505 via the SUB1 L1/RF SW 530 and SUB2 L1/RF SW 550. The SW Coex LIB 520 may store the transmission/reception registration information and detect/identify long term conflicts between the two transceivers 510, 515, e.g., identify time-frequency resources subject to in-device coexistence interference. Each of SUB1 L1/RF SW 530 and SUB2 L1/RF SW 550 may communicate the long term registration information to the SW Coex LIB 520 at the frame or code block level via links 570, 571. The conflict/interference information may then be communicated back to the SUB1 L1/RF SW 530 and SUB2 L1/RF SW 550 of transceivers 510, 515 to be used to apply a resource-specific mitigation action to received transmissions, in accordance with the techniques described above.

The USTMR 580 may provide a common time reference to enable the coexistence manager 505 to detect transmission and reception activity overlap between transceivers 510, 515. Time transfer dumps may be used to convert RTC times from SUB1 RTC 545 and SUB2 RTC 565 to USTMR time.

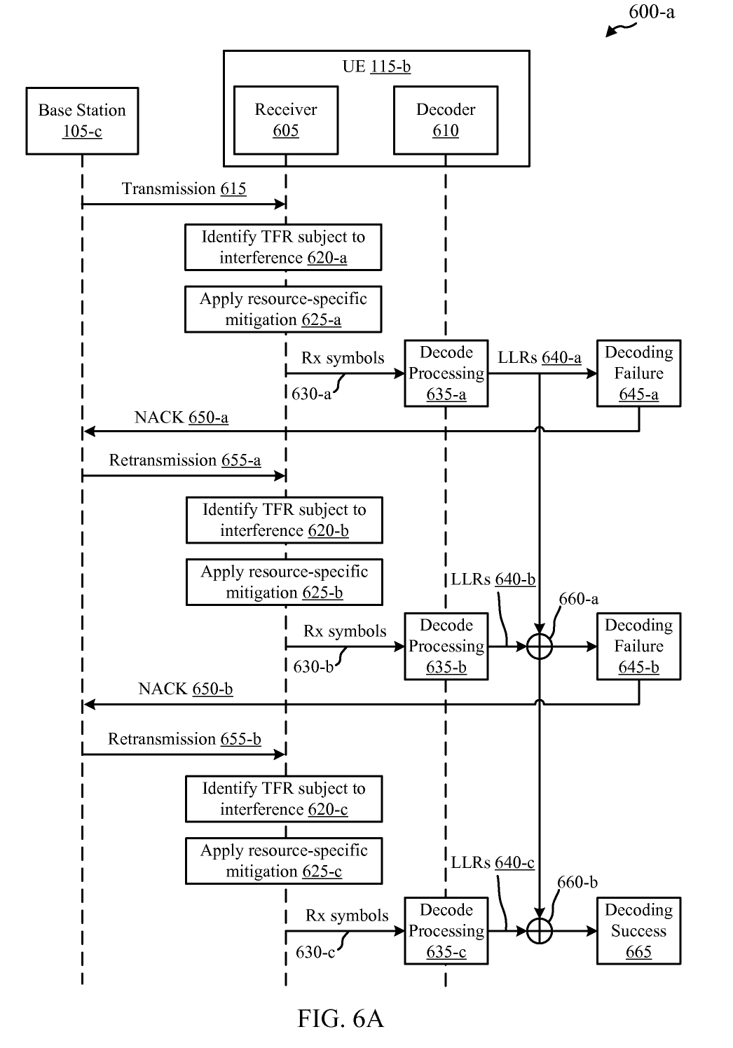

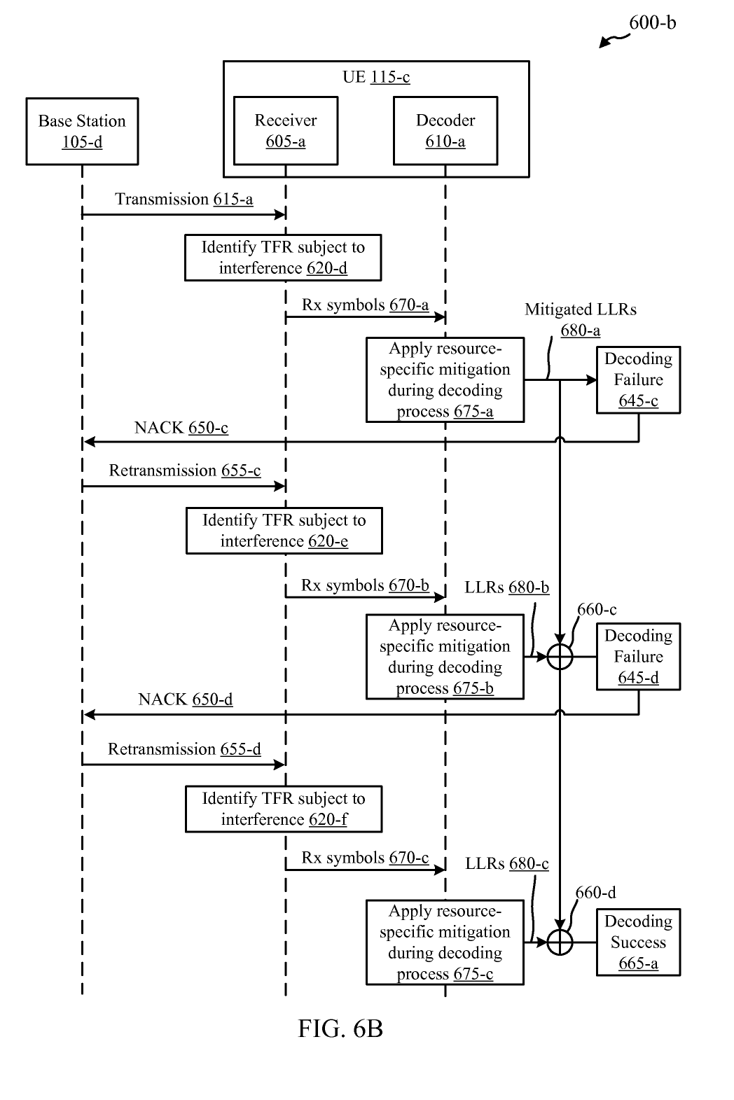

FIG. 6A illustrates a flow diagram 600-a illustrating a method for applying resource-specific interference mitigation to identified time-frequency resources (TFR) subject to in-device coexistence interference by a UE 115-b, in accordance with various embodiments. The UE 115-b may receive one or more transmissions from a base station 105-c, for example one or more OFDM transmissions via component carrier 400, that are subject to in-device coexistence interference. The UE 115-b may include a receiver 605 and a decoder 610, for example associated with a first transceiver, which may be an example of one or more aspects of transceiver 205 and/or 510 described in reference to FIGS. 2 and/or 5. The in-device coexistence interference may be caused by one or more concurrent transmissions (or receptions) of another transceiver of the UE 115-b, for example transceiver 210 and/or 515 described in reference to FIGS. 2 and/or 5. UE 115-b may be an example of one or more aspects of UEs 115 described above in reference to previous Figures, and base station 105-c may similarly be an example of one or more aspects of base stations 105 described above in reference to previous Figures.

The base station 105-c may first send a transmission at 615 to UE 115-b, which may be received by receiver 605. The UE 115-b may then identify time-frequency resources (TFR) of the received signal that are subject to coexistence interference at 620-a via the techniques described above in reference to FIGS. 4 and 5, such as via a coexistence manager 505 or by utilizing CRSs 455, for example. In some implementations, the identifying may be performed at the receiver 605 of UE 115-b; in other cases, however, other processors and/or components of the UE 115-b may perform the identifying, such as coexistence manager 505 of FIG. 5. The receiver 605 (or coexistence manager, in some cases) may apply resource-specific interference mitigation at 625-a. The resource-specific interference mitigation may include skipping or nulling time-frequency resources of the received signal, as described above in reference to FIGS. 4 and 5.

The mitigated received symbols of the received signal may then be communicated to the decoder 610 at 630-a. The decoder 610 may apply decoding processing to the mitigated received signal at 635-a and generate LLR instances to be used in soft combining of the received signal through a HARQ process. The decoding processing may include demodulating the received signal (e.g., based on QSPK, 16 QAM, etc., modulation schemes). The decoder 610 may then evaluate the LLR instances at 640-a to determine if the transmission 615 can be successfully decoded. Due to the in-device coexistence interference, the decoding procedure may fail at 645-a, and a NACK may be sent at 650-a to base station 105-c requesting retransmission of the transmission sent at 615.

However, by skipping or nulling time-frequency resources identified as subject to coexistence interference (applying resource-specific interference mitigation) and inputting the mitigated symbols into the decoder 610, the decoding process may not fail in the first instance at 645-a. Applying the resource specific mitigation may allow the decoding process to provide the corrected transmission, for example based on error detection/redundancy in the transmission itself. This may be accomplished, for instance, by skipping a sub-carrier that is subject to interference, while the same or redundant information is transmitted on a different sub-carrier of the component carrier. By skipping the interfered sub-carrier, the decoding processing 635-a may correctly decode the transmission 615, even though fewer than all time-frequency resources of the transmission 615 were used in the decoding process. Similarly, other resource specific mitigation techniques may yield similar results, for example including skipping or nulling slots, symbols, etc.

In the event applying resource-specific mitigation is not successful for transmission 615, and a decoding failure is detected at 645-a, the base station 105-c may retransmit the message at 655-a in response to the NACK transmitted at 650-a. As described above, retransmission 655-a may include the same information as transmission 615 (e.g., chase combining), or different or redundant information for the same message or transport block (e.g., incremental redundancy). Again, the receiver 605 of UE 115-a may identify the time-frequency resources of retransmission 655-a subject to in-device coexistence interference at 620-b, apply a resource-specific interference mitigation action at 625-b and communicate the mitigated received signal to the decoder 610 at 630-b. The decoder 610 may then run the mitigated received signal through decoding processing 635-b and soft combine LLR instances generated from the decoding 640-b with the LLR instances 640-a from the first transmission 615 at 660. Again the resource-specific mitigation may reduce the effects of the coexistence interference in the decoding and soft combining procedures. However, in the illustrated example, the decoding may again fail at 645-b and a second NACK 650-b may be sent to the base station 105-c to request a second retransmission of the transport block.

The process may then repeat with the base station 105-c sending a second retransmission at 655-b. The receiver 605 of UE 115-a may identify the time-frequency resources subject to in-device coexistence interference at 620-c, apply a resource-specific interference mitigation action at 625-c and communicate the mitigated received signal to the decoder 610 at 630-c. The decoder 610 may then run the mitigated received signal through decoding processing 635-c and further combine LLR instances from the second retransmission 655-b with the LLR instances from the earlier transmissions and retransmissions at 660-b. Because each of the transmissions 615 or retransmissions 655 may be subject to in-device coexistence interference, without mitigation the in-device coexistence interference may cause some LLR instances generated from each transmission to have large error or uncertainty. Thus, applying resource-specific mitigation (e.g., skipping or nulling interfered resources) as described above may enable the decoder 610 to successfully decode the message or transport block at 665, where without mitigation decoding would again fail after soft combining the transmissions and retransmissions at 660-b. That is, even though less information may be decoded at each decode processing step 635, because the high uncertainty that may result from decoding symbols with strong coexistence interference is not propagated through the decoding process, the decoding process including soft combining may have a higher likelihood of successful decoding of the message or transport block.

By applying the resource specific mitigation techniques at 625 to the received time-frequency resources subject to in-device coexistence interference, the number of retransmissions 655 required to successfully receive and decode the transmission 615 may therefore be reduced. This may result in less power consumption by the UE 115-b in having to request fewer retransmissions to successfully decode a message or transport block. This may also result in greater throughput for communications between the UE 115-b and the base station 105-c.

FIG. 6B illustrates a flow diagram 600-b illustrating another method for applying resource-specific interference mitigation to identified time-frequency resources subject to in-device coexistence interference by a UE 115-c, in accordance with various embodiments. The UE 115-c may receive one or more transmissions from a base station 105-d, for example one or more OFDM transmissions including component carrier 400 as described in reference to FIG. 4, that are subject to in-device coexistence interference. The UE 115-c may include a receiver 605-a and a decoder 610-a, and may be an example of one or more aspects of UE 115-b described in reference to FIG. 6A. The receiver 605-a and a decoder 610-a may be associated with a first transceiver, which may be an example of one or more aspects of transceiver 205 described in reference to FIG. 2 or transceiver 510 of FIG. 5. The in-device coexistence interference may be caused by one or more concurrent transmissions (or receptions) of another transceiver of the UE 115-c, for example transceiver 210 described in reference to FIG. 2 or transceiver 515 of FIG. 5. UE 115-c may be an example of one or more aspects of UEs 115 described above in reference to previous Figures, and base station 105-d may similarly be an example of one or more aspects of base stations 105 described above in reference to previous Figures.

The base station 105-d may first send a transmission at 615-a to UE 115-c, which may be received by receiver 605-a. The UE 115-c may then identify time-frequency resources of the received signal that are subject to coexistence interference at 620-d via the techniques described above in reference to FIGS. 4 and 5, such as via coexistence manager 505 or by utilizing CRSs 455, for example. In some implementations, the identifying may be performed at the receiver 605-a of UE 115-c; in other cases, however, other processors and/or components of the UE 115-c may perform the identifying, such as coexistence manager 505 of FIG. 5.

The receiver 605-a may then communicate the received symbols of the received transmission to the decoder 610-a at 670-a along with information identifying the interfered time-frequency resources. The decoder 610-a may then apply resource-specific interference mitigation during the decoding process 675-a. This may include skipping or nulling LLR instances that correspond to the identified time-frequency resources subject to coexistence interference, via the techniques described above. The mitigated LLR instances may then be evaluated at 680-a. Due to the in-device coexistence interference, the soft combining procedure may fail at 645-c, and a NACK may be sent at 650-c to base station 105-d requesting retransmission of the message or transport block sent at 615-a.

In response to NACK 650-c, the base station 105-d may send a retransmit the message at 655-c. Again, the receiver 605-a of UE 115-a may then identify the time-frequency resources subject to in-device coexistence interference at 620-e and communicate the received signal to the decoder 610-a at 670-b along with information identifying the interfered time-frequency resources. The decoder 610-a may then apply resource-specific interference mitigation during the decoding process 675-b to the corresponding LLR instances. In some examples, resource-specific mitigation for transmission 655-c may include skipping or nulling some or all LLRs 680-b associated with the transmission. For example, if a large number (e.g., greater than a threshold such as 50% of LLRs, etc.) are determined to be corrupted with coexistence interference present on the received signal, the soft-combining step 660-c may be skipped and decoding failure declared at 645-d, resulting in a second NACK 650-d to provoke a second retransmission. In other examples, the mitigated LLR instances 680-b (e.g., with some LLR instances skipped or nulled) may then be combined (e.g., summed, etc.) with the LLRs 680-a associated with the first transmission 615-a at 660-c. However, in the example illustrated, the soft combining procedure may fail at 645-d. In this scenario, a second NACK 650-d may be sent to the base station 105-d requesting a second retransmission. This process may continue to repeat until the soft combining indicates that the message has been successfully received, for example at 665-a.

The soft combining process may be affected in different ways by different types of interference. For example, when the same transmission (e.g., in chase combing) is received two or more times with interference, the soft combing process may provide for a corrected transmission. This may be the case regardless of whether the transmission and retransmission experience the same interference. For example, the LLRs from the transmission and retransmission may each result in uncertainty levels that are below a level indicating a successful decode operation. However, when combined (e.g., summed, etc.), the combined LLRs may satisfy the threshold for successful decoding.

However, in other instances, for example when the interference is strong enough to significantly degrade the transmission, is sporadic, etc., current soft combining techniques may propagate the interference and inhibit or delay the successful decoding. This may be the case where a transport block or other resource of the transmission is subject to high levels of interference in one or more of multiple transmissions or retransmissions. In this case, the combining of LLRs that correspond to resources subject to high levels of interference may actually decrease the confidence level indicating error free decoding. As a result, the soft combining of corrupted LLRs may delay or completely prevent the successful decoding of the transport block. In this and other similar scenarios where error propagation may occur, the described interference mitigation techniques, including skipping or nulling interfered LLRs, may improve soft combining performance. The described techniques may reduce the number of retransmission required to obtain an error free transmission, decrease the BLER, and increase overall throughout of the device.

Thus, the techniques illustrated in FIG. 6B may reduce the number of retransmissions needed for successful decoding of the message or transport block. For example, where one set of LLRs (e.g., LLRs 680-b) suffers from high effects of co-existence interference, skipping or nulling the LLRs from that transmission may allow successful decoding based on the LLRs (e.g., LLRs 680-a and 680-c) associated with other transmissions.

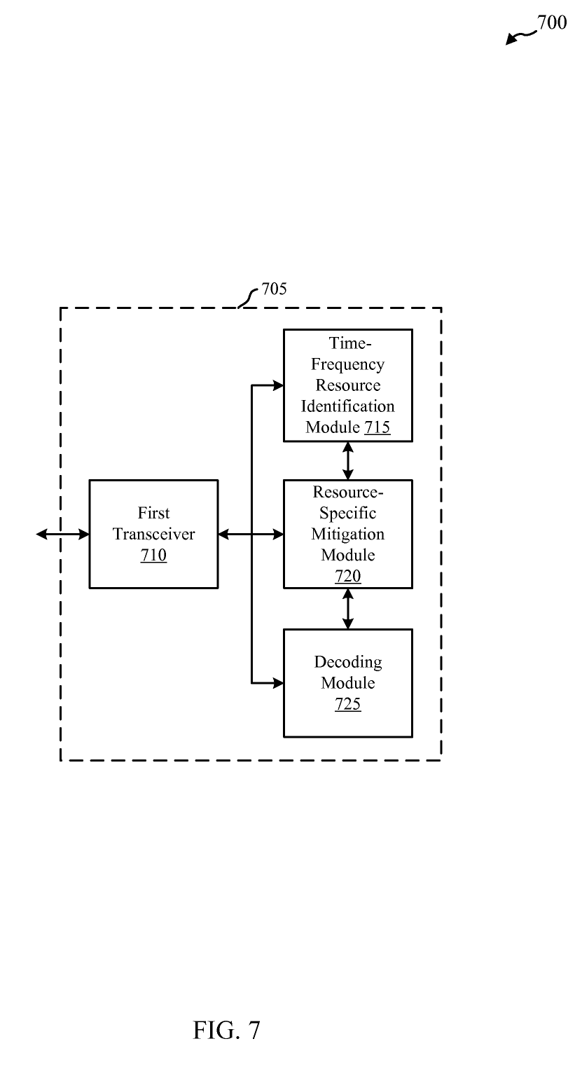

FIG. 7 shows a block diagram 700 illustrating an example of a device 705 that may be configured for applying resource-specific interference mitigation to identified time-frequency resources subject to in-device coexistence interference in accordance with various embodiments. The device 705 may be an example of one or more aspects of UEs 115 or base stations 105 described with reference to previous Figures. The device 705 may include a first transceiver 710, a time-frequency resource identification module 715, a resource-specific mitigation module 720, and a decoding module 725, each of which, in embodiments, may be communicably coupled with any or all of the other components.

The first transceiver 710 may be used to transmit and receive various types of data and/or control signals in a wireless communications system such as the wireless communication systems 100 and/or 200 as described in reference to FIGS. 1 and 2. In some aspects, the first transceiver 710 may be configured to communicate via OFDM/OFDMA radio access technologies. First transceiver 710 may be an example of one or more aspects of transceiver 205 or transceiver 510 described in reference to FIGS. 2 and 5, or receiver 605 and decoder 610 described in reference to FIGS. 6A and 6B. The transceiver 710, either alone or in combination with other components, may be means for communicating as described herein. In some cases, the first transceiver 710 may receive one or more signals subject to coexistence interference caused by another transceiver (not shown) of a UE 115 or base station 105, for example implementing a different radio access technology such as GSM, Bluetooth, CDMA, etc.

The first transceiver 710 may receive an OFDM signal, which may include one or more component carriers as described above in reference to FIG. 4. Concurrently, another transceiver of the UE 115 or base station 105 may transmit (or receive) one or more messages via a different radio access technology, which may cause in-device coexistence interference on the signal received by the first transceiver 710. In one embodiment, the time-frequency resource identification module 715 may identify time-frequency resources of the received OFDM signal subject to interference from the concurrent transmission(s) of the other transceiver, via the techniques described above. In some aspects, the time-frequency resource identification module 715 may implement one or more aspects of the coexistence manager 505 described in reference to FIG. 5. In some aspects, the time-frequency resource identification module 715 may implement the CRS comparison techniques described above in reference to FIG. 4 to identify the time-frequency resources subject to coexistence interference.

The resource-specific mitigation module 720 may receive information related to the time-frequency resources identified as subject to coexistence interference from the time-frequency resource identification module 715. The resource-specific mitigation module 720 may then apply one or more resource-specific mitigation actions to the resources identified as subject to coexistence interference. This may include skipping or nulling time-frequency resources of the received signal subject to the interference, such as one or more symbols, slots, sub-frames, sub-carriers, etc. The resource-specific mitigation module 720 may then communicate the mitigated received signal (e.g., including nulled or skipped symbols/bits, etc.) to the decoding module 725, where the appropriate decoding process may be applied to the received signal based on the code rate and modulation scheme used for the transmission.

In some implementations, the decoding module 725 may also implement a soft combiner/HARQ module. In this scenario, the resource-specific mitigation module 720 (or the time-frequency resource identification module 715) may be configured to map time-frequency resources identified as subject to coexistence interference by the time-frequency resource identification module 715 to LLRs generated by the decoding module 725. The resource-specific mitigation module 720 may then apply resource-specific interference mitigation to the LLRs, for example skipping or nulling LLRs that correspond to interfered time-frequency resources, as described in greater detail above. The mitigated LLRs may then be communicated to the soft combiner of the decoding module 725. The soft combiner may combine the LLRs from multiple transmissions according to the mitigated LLRs. These techniques may prevent corrupt LLRs from propagating in the soft-combining procedure, resulting in a higher likelihood of successful decoding from multiple transmissions or retransmissions.

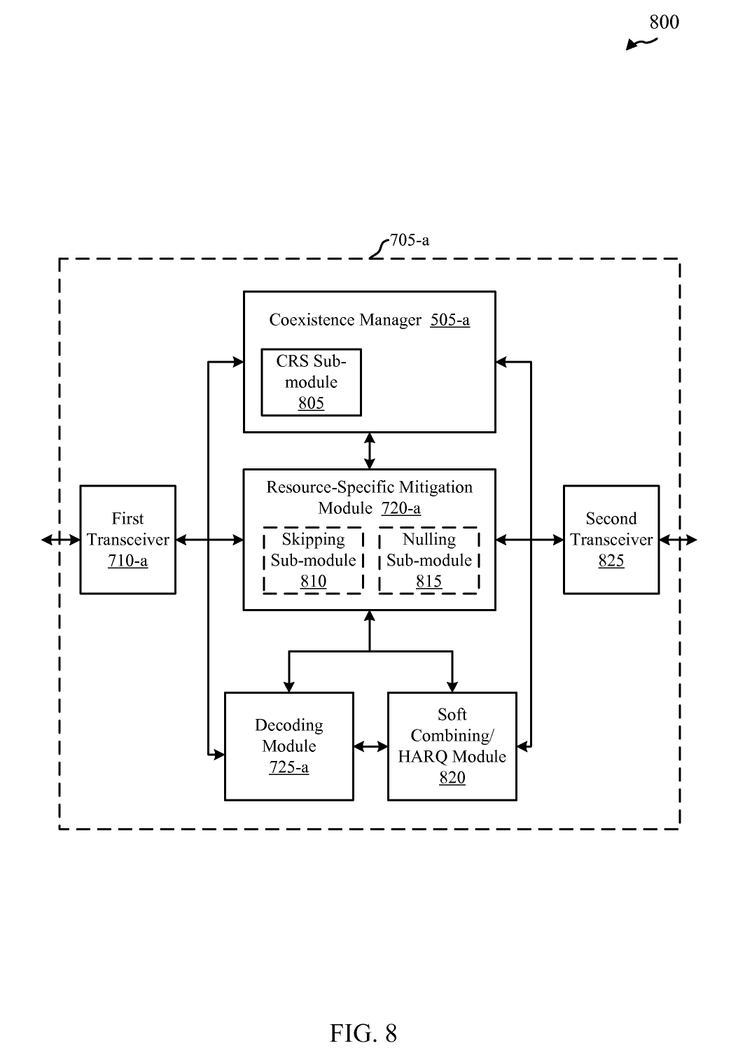

FIG. 8 shows a block diagram 800 illustrating another example of a device 705-a that may be configured for applying resource-specific interference mitigation to identified time-frequency resources subject to in-device coexistence interference in accordance with various embodiments. The device 705-a may be an example of one or more aspects of device 705 described in reference to FIG. 7, and/or UEs 115 or base stations 105 described with reference to previous Figures. The device 705-a may include a first transceiver 710-a, a coexistence manager 505-a including a CRS sub-module 805, a resource-specific mitigation module 720-a, a decoding module 725-a, a soft combining/HARQ module 820, and a second transceiver 825, each of which, in embodiments, may be communicably coupled with any or all of the other components. Resource-specific mitigation module 720-a may include either or both of skipping sub-module 810 or nulling sub-module 815 for skipping or nulling samples of received signals associated with interfered time-frequency resources and/or LLRs.

The first transceiver 710-a and the decoding module 725-a may implement one or more aspects of the first transceiver 710 and the decoding module 725 described in reference to FIG. 7. Accordingly, similar functionality of these components will not be described again here.

The second transceiver 825 may be used to transmit and receive various types of data and/or control signals in a wireless communications system such as the wireless communication systems 100 and/or 200 as described in reference to FIGS. 1 and 2. In some aspects, the second transceiver 825 may be configured to communicate via other radio access technologies such as GSM, Bluetooth, CDMA, WCDMA, or Wi-Fi. Second transceiver 825 may be an example of one or more aspects of transceiver 210 and/or 515 described in reference to FIGS. 2 and/or 5. The transceiver 825, either alone or in combination with other components, may be means for communicating as described herein. In some cases, the first transceiver 710-a may receive one or more signals subject to coexistence interference caused by the second transceiver 825. For the sake of explanation, device 705-a is only shown with two transceivers or radios; however, it should be appreciated that device 705-a may include any number of transceivers/radios that each may support one or more radio access technologies.

The coexistence manager 505-a may receive transmission/reception information from the first transceiver 710-a and the second transceiver 825. The coexistence manager 505-a may be an example of one or more aspects of coexistence manager 505 and/or the time-frequency resource identification module 715 described in reference to FIGS. 5 and 7 above. The coexistence manager 505-a may identify time-frequency resources of a signal received by first transceiver 710-a that are subject to interference. In some cases, the time-frequency resources may be identified by the CRS sub-module 805 of the coexistence manager 505-a according to the techniques described above in reference to FIG. 4.

The resource-specific mitigation module 720-a may receive the identity of the time-frequency resources identified as subject to coexistence interference from the coexistence manager 505-a. The resource-specific mitigation module 720-a may then apply one or more resource-specific mitigation actions to the resources identified as subject to coexistence interference, as described above. For example, the skipping sub-module 810 of the resource-specific mitigation module 720-a may skip one or more of the identified time-frequency resources identified by the coexistence manager 505-a to be subject to coexistence interference before communicating the received transmission to the decoding module 725-a and/or the soft combining/HARQ module 820. Similarly, the nulling sub-module 815 of the resource-specific mitigation module 720-a may null one or more of the identified time-frequency resources identified by the coexistence manager 505-a to be subject to coexistence interference before communicating the received transmission to the decoding module 725-a and/or the soft combining/HARQ module 820. In some embodiments, only one of the skipping sub-module 810 or the nulling sub-module 815 may be implemented and/or active in the resource-specific mitigation module 720-a. In other embodiments, both the skipping sub-module 810 and the nulling sub-module 815 may be implemented or active in the resource-specific mitigation module 720-a. By applying resource-specific interference mitigation to the received time-frequency resources subject to interference, reception performance of the device 705-a may be increased.

In some embodiments, the mitigated time-frequency resources (e.g., the received transmission after skipping and/or nulling have been applied) may then be communicated to the decoding module 725-a to be decoded. The decoding module 725-a may generate LLRs corresponding to the received transmission and communicate the LLRs to the soft combining/HARQ module 820. The soft combining/HARQ module 820 may combine the LLRs to determine a likelihood that the transmission was received without error. If the confidence level is below a decoding successful threshold, the soft combining/HARQ module 820 may then instruct the first transceiver 710-a to transmit a NACK to the sending device (e.g., a base station 105), to request retransmission of the transmission. The decoding and/or soft combining by the decoding module 725-a and the soft combining/HARQ module 820 may be performed as described above in reference to FIGS. 6A and 6B. In this way, decoding of the received transmission in the first instance may be improved by decreasing decoding failure, as described above.

In some embodiments, the received transmission may be communicated from the first transceiver 710-a directly to the decoding module 725-a. Additionally the received transmission may be communicated to the coexistence manager 505-a so that interfered resources may be identified and indicated to the resource-specific mitigation module 720-a. The decoding module 725-a may communicate LLRs generated from the received transmission to the resource-specific mitigation module 720-a. The resource-specific mitigation module 720-a may then apply resource-specific mitigation to the LLRs to improve the soft combining procedure, as described above. In one example, the skipping sub-module 810 of the resource-specific mitigation module 720-a may skip one or more of the LLRs corresponding to the time-frequency resources identified by the coexistence manager 505-a to be subject to coexistence interference before communicating the LLRs to the soft combining/HARQ module 820. Similarly, the nulling sub-module 815 of the resource-specific mitigation module 720-a may null one or more LLRs corresponding to time-frequency resources identified by the coexistence manager 505-a to be subject to coexistence interference before communicating the LLRs to the soft combining/HARQ module 820. The soft combining/HARQ module 820 may combine the LLRs to determine a likelihood that the transmission was received without error and instruct the first transceiver 710-a to transmit a NACK to the sending base station accordingly.

By implementing interference mitigation at the LLR level, soft combining performance may be increased, while reducing error prorogation in the soft combining process, as described in greater detail above. This may increase throughput of communications with the sending device (e.g., base station 105).

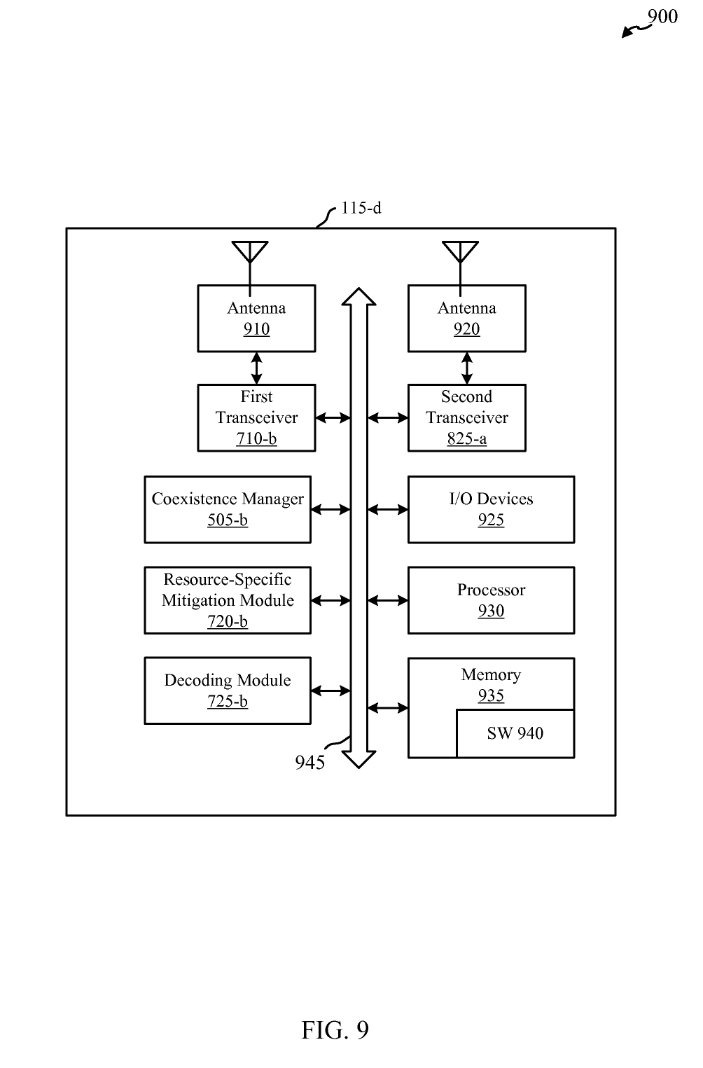

FIG. 9 is a block diagram 900 of a UE 115-d configured for applying resource-specific interference mitigation to identified time-frequency resources subject to in-device coexistence interference in accordance with various embodiments. The UE 115-d may be an example of one or more aspects of the UEs 115 and/or device 705 and/or may implement one or more aspects of the coexistence manager 505 described above with reference to the previous Figures. The UE 115-d may communicate with at least one base station 105 and/or another UE 115 as described above in reference to FIGS. 1, 2, 6A, and/or 6B. The UE 115-d may have any of various configurations, such as personal computers (e.g., laptop computers, netbook computers, tablet computers, etc.), smartphones, cellular telephones, PDAs, wearable computing devices, digital video recorders (DVRs), internet appliances, routers, gaming consoles, e-readers, display devices, printers, etc. The UE 115-d may have an internal power supply (not shown), such as a small battery, to facilitate mobile operation.

The components of the UE 115-d may, individually or collectively, be implemented using at least one application-specific integrated circuit (ASIC) adapted to perform some or all of the applicable functions in hardware. Alternatively, the functions may be performed by at least one other processing unit (or core), on at least one integrated circuit. In other examples, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by at least one general or application-specific processor.

The UE 115-d includes antennas 910, 920, a first transceiver 710-b, a second transceiver 825-a, a memory 935, a processor 930, and I/O devices 925, which each may be in communication, directly or indirectly, with each other, for example, via at least one bus 945. The first transceiver 710-b and the second transceiver 825-a may be an example of one or more aspects of transceivers 710, 825 described in reference to previous Figures. The first transceiver 710-b and the antenna 910 may be configured to communicate via OFDM/OFDM radio access technologies, such as LTE/LTE, via links 125 described in reference to the previous Figures. The second transceiver 825-a and the antenna 920 may be configured to communicate via another radio access technology, such as GSM, Bluetooth, CDMA, WCDMA, Wi-Fi, etc., via any of links 125 described in reference to the previous Figures. Each transceiver 710-b, 825-a may be configured to communicate bi-directionally, via the antennas 910, 920. The transceivers 710-b, 825-a may, in conjunction with the antennas 910, 920, transmit and receive packets. The UE 115-d may be capable of employing multiple antennas 910, 920 for transmitting and receiving communications in a multiple-input multiple-output (MIMO) communication system.

The memory 935 may include random access memory (RAM) and read-only memory (ROM). The memory 935 may store computer-readable, computer-executable software code 940 containing instructions that are configured to, when executed, cause the processor 930 to perform various functions described herein. Alternatively, the software 940 may not be directly executable by the processor 930 but may be configured to cause the computer (e.g., when compiled and executed) to perform functions described herein. The processor 930 may include an intelligent hardware device, e.g., a central processing unit (CPU), a microcontroller, an application specific integrated circuit (ASIC), etc.

According to the architecture of FIG. 9, the UE 115-d may further include a coexistence manager 505-b, a resource-specific mitigation module 720-b, and a decoding module 725-b. By way of example, these components of UE 115-d may be in communication with some or all of the other components of the UE 115-d via bus 945. Additionally or alternatively, functionality of these components or modules may be implemented via the transceivers 710-b, 825-a, as a computer program product stored in software 940, and/or as at least one controller element of the processor 930. In some embodiments, the coexistence manager 505-b, the resource-specific mitigation module 720-b, and the decoding module 725-b may be implemented as subroutines in memory 935/software 940, executed by the processor 930. In other cases, these modules may be implemented as sub-modules in the processor 930 itself.

The coexistence manager 505-b, resource-specific mitigation module 720-b, and decoding module 725-b may be examples of one or more aspects of coexistence manager 505, resource-specific mitigation module 720, and decoding module 725 described above in reference to FIGS. 5, 7, and/or 8. The coexistence manager 505-b may identify time-frequency resources of a signal received by the first transceiver 710-b subject to coexistence interference caused by a concurrent transmission (or reception) of the second transceiver 825-a. The resource-specific mitigation module 720-b may apply resource-specific mitigation to the time-frequency resources and/or LLRs corresponding to interfered time-frequency resources identified by the coexistence manager 505-b. The decoding module 725-b may decode the received signal and/or soft combine LLRs corresponding to the received signal to implement one or more HARQ procedures. For the sake of brevity, these components will not be described in greater detail here.

In some aspects, each transceiver 710-b, 825-a may include a modem configured to modulate the packets and provide the modulated packets to the antennas 910, 920 for transmission, and to demodulate packets received from the antennas 910, 920. In some aspects, the decoding module 725-b may be implemented in the transceiver 710-b to enable the techniques described herein. In other cases, as illustrated, the decoding module 725-b may be a separate component form the first transceiver 710-b.

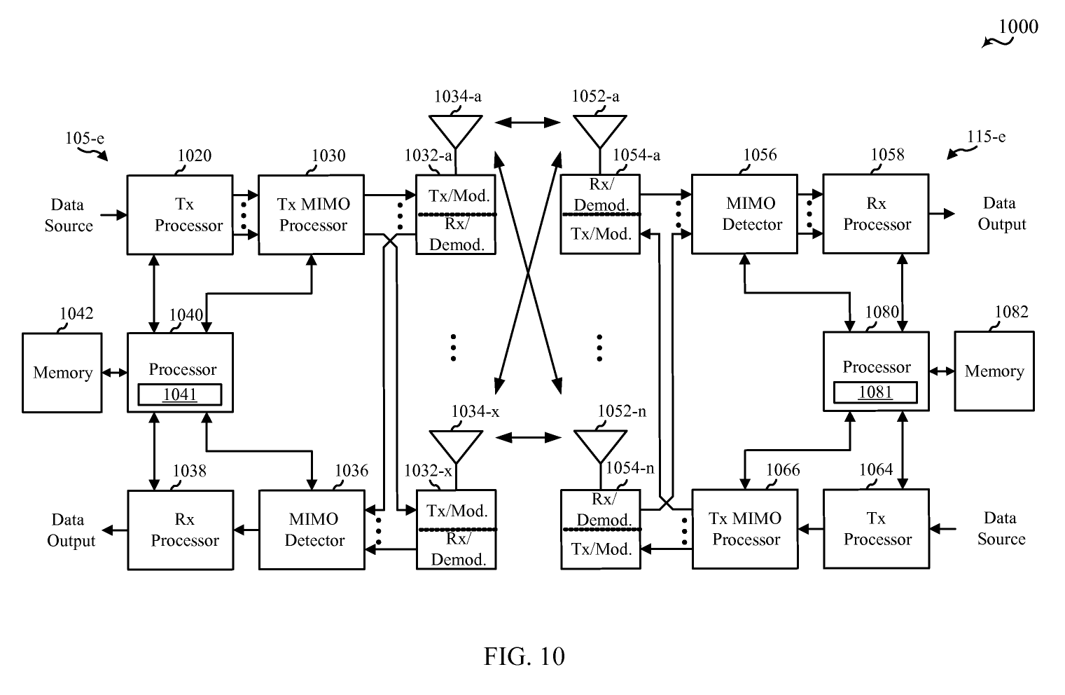

FIG. 10 is a block diagram of a MIMO communication system 1000 including a base station 105-e and a UE 115-e. This system 1000 may illustrate aspects of the system 100 of FIG. 1 and/or system 200 of FIG. 2. The base station 105-e may be equipped with antennas 1034-a through 1034-x, and the UE 115-e may be equipped with antennas 1052-a through 1052-n. In the system 1000, the base station 105-e may be able to send data over multiple communication links at the same time. Each communication link may be called a “layer” and the “rank” of the communication link may indicate the number of layers used for communication. For example, in a 2×2 MIMO system where base station 105-e transmits two “layers,” the rank of the communication link between the base station 105-e and the UE 115-e is two.

At the base station 105-e, a transmit processor 1020 may receive data from a data source. The transmit processor 1020 may process the data. The transmit processor 1020 may also generate reference symbols. A transmit (TX) MIMO processor 1030 may perform spatial processing (e.g., precoding) on data symbols, control symbols, and/or reference symbols, if applicable, and may provide output symbol streams to the transmit modulators 1032-a through 1032-x. Each modulator 1032 may process a respective output symbol stream (e.g., for OFDM, etc.) to obtain an output sample stream. Each modulator 1032 may further process (e.g., convert to analog, amplify, filter, and upconvert) the output sample stream to obtain a downlink (DL) signal. In one example, DL signals from modulators 1032-a through 1032-x may be transmitted via the antennas 1034-a through 1034-x, respectively.

At the UE 115-e, the UE antennas 1052-a through 1052-n may receive the DL signals from the base station 105-e and may provide the received signals to the demodulators 1054-a through 1054-n, respectively. Each demodulator 1054 may condition (e.g., filter, amplify, downconvert, and digitize) a respective received signal to obtain input samples. Each demodulator 1054 may further process the input samples (e.g., for OFDM, etc.) to obtain received symbols. A MIMO detector 1056 may obtain received symbols from all the demodulators 1054-a through 1054-n, perform MIMO detection on the received symbols if applicable, and provide detected symbols. A receive processor 1058 may process (e.g., demodulate, deinterleave, and decode) the detected symbols, providing decoded data for the UE 115-e to a data output, and provide decoded control information to a processor 1080, or memory 1082. The processor 1080 may include a resource specific interference mitigation module 1081. The resource specific interference mitigation module 1081 may be an example of aspects of the resource specific interference mitigation module 720, coexistence manager 505, time-frequency resource identification module 715, and/or decoding module 725 described in reference to the previous Figures. Upon the UE 115-e receiving a transmission or retransmission of a transport block to decode, resource specific interference mitigation module 1081 may apply resource-specific interference mitigation to mitigate interference caused by another transceiver of the UE 115-e implementing a different radio access technology, as described above with reference to previous Figures.

On the uplink (UL), at the UE 115-e, a transmit processor 1064 may receive and process data from a data source. The transmit processor 1064 may also generate reference symbols for a reference signal. The symbols from the transmit processor 1064 may be precoded by a transmit MIMO processor 1066 if applicable, be further processed by the demodulators 1054-a through 1054-n (e.g., for SC-FDMA, etc.), and be transmitted to the base station 105-e in accordance with the transmission parameters received from the base station 105-e. At the base station 105-e, the UL signals from the UE 115-e may be received by the antennas 1034, processed by the demodulators 1032, detected by a MIMO detector 1036 if applicable, and further processed by a receive processor 1038. The receive processor 1038 may provide decoded data to a data output and to the processor 1040, or memory 1042. The processor 1040 may include a resource specific interference mitigation module 1041. The resource specific interference mitigation module 1041 may be an example of aspects of the resource specific interference mitigation module 720, coexistence manager 505, time-frequency resource identification module 715, and/or decoding module 725 described in reference to the previous Figures. Upon the base station 105-e receiving a transmission or retransmission of a transport block to decode, resource specific interference mitigation module 1041 may apply resource-specific interference mitigation to mitigate interference caused by another transceiver of the base station 105-e implementing a different radio access technology, as described above with reference to previous Figures.

The components of the UE 115-e may, individually or collectively, be implemented with one or more Application Specific Integrated Circuits (ASICs) adapted to perform some or all of the applicable functions in hardware. Each of the noted modules may be a means for performing one or more functions related to operation of the system 1000. Similarly, the components of the base station 105-e may, individually or collectively, be implemented with one or more Application Specific Integrated Circuits (ASICs) adapted to perform some or all of the applicable functions in hardware. Each of the noted components may be a means for performing one or more functions related to operation of the system 1000.

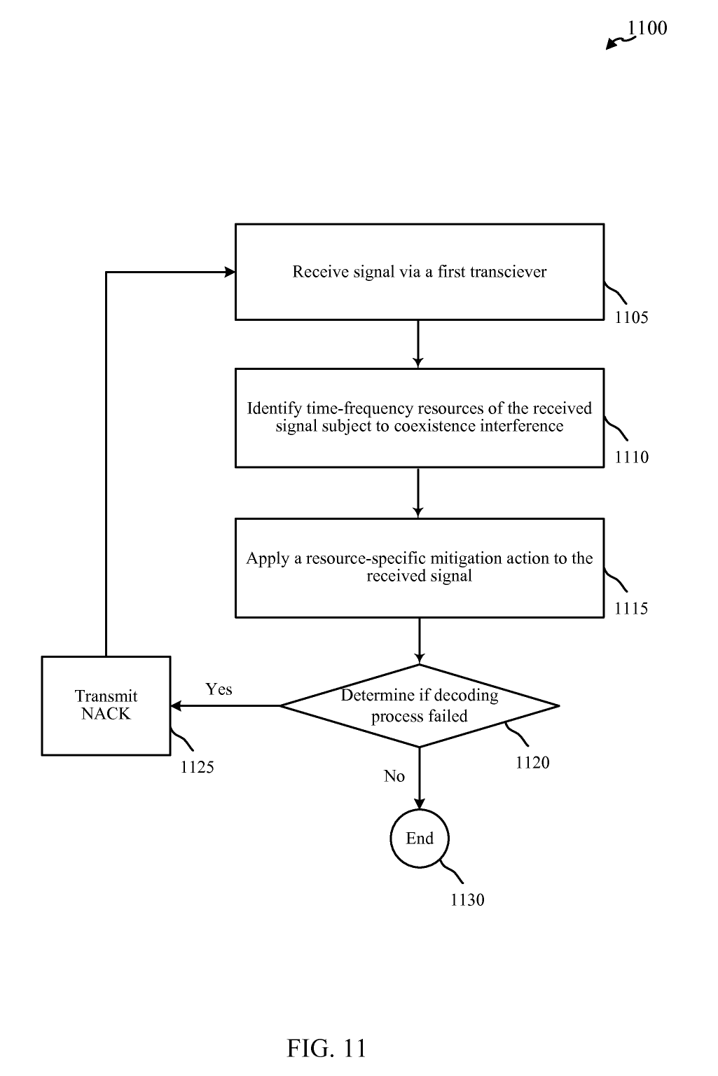

FIG. 11 is a flow chart illustrating one example of a method 1100 for applying resource-specific interference mitigation to identified time-frequency resources subject to in-device coexistence interference in accordance with various embodiments. For clarity, the method 1100 is described below with reference to one or more aspects of UEs 115 and/or devices 705 (or base stations 105) described with reference to the previous Figures. In some embodiments, a device such as one of the UEs 115 or devices 705 may execute one or more sets of codes to control the functional elements of the UE 115 or device 705 to perform the functions described below.

At block 1105, a device 705 (which may be implemented in a UE 115 or base station 105) of the previous Figures, may receive a signal (e.g., an OFDM signal) via a first transceiver of the device 705. The received signal may experience coexistence interference from another transceiver of the device 705, for example, that is concurrently transmitting or receiving a message via another radio access technology.

At block 1110, the device 705 may identify time-frequency resources of the received signal subject to the coexistence interference. The identifying of the interfered time-frequency resources may be performed, for example by the transceiver 205, 510, 710/receiver 605 of the device 705, a coexistence manager 505, or a time-frequency resource identification module 715 of the device 705 as described above in reference to the previous Figures. The identifying may include comparing reference signals of the received transmission (e.g., CRSs as described in reference to FIG. 4), or obtaining information from the interfering transceiver, for example via the coexistence manager 505 as described in reference to FIG. 5, for example. In some instances, identifying the interfered resources/determining the resource conflict may be based at least in part on an interference kernel of a predetermined radio frequency non-linearity.

At block 1115, the device 705 may apply a resource-specific mitigation action for the received signal during a decoding operation of the received signal based at least in part on the identified time-frequency resources. The resource-specific mitigation action may include skipping or nulling the interfered time-frequency resources, and/or skipping or nulling LLRs generated by the decoding process that correspond to the identified interfered resources. In some implementations, a decoder 610/decoding module 725, or resource-specific interference mitigation module 720 may apply the resource-specific interference mitigation to the interfered resources or corresponding LLRs.

At block 1120, the device 705 may determine if the decoding or soft combing process has failed. This may be performed, for example by the decoding module 725 and/or the soft combing/HARQ module described in reference to the previous Figures. The determining may include comparing the decoded signal to one or more signal or confidence thresholds, or comparing the LLRs to an LLR confidence threshold. If the device 705 determines that the decoding has fails, the device may transmit a NACK at block 1125 to request retransmission by the sending device (e.g., base station 105). The method 1100 may then begin at block 1105 again and continue to repeat until the decoding process is determined to be successful at block 1120, at which time the method may terminate at 1130.

Thus, the method 1100 may provide for coexistence interference mitigation by a wireless device. It should be noted that the method 1100 is one example implementation and that the operations of the method 1100 may be rearranged or otherwise modified such that other implementations are possible.

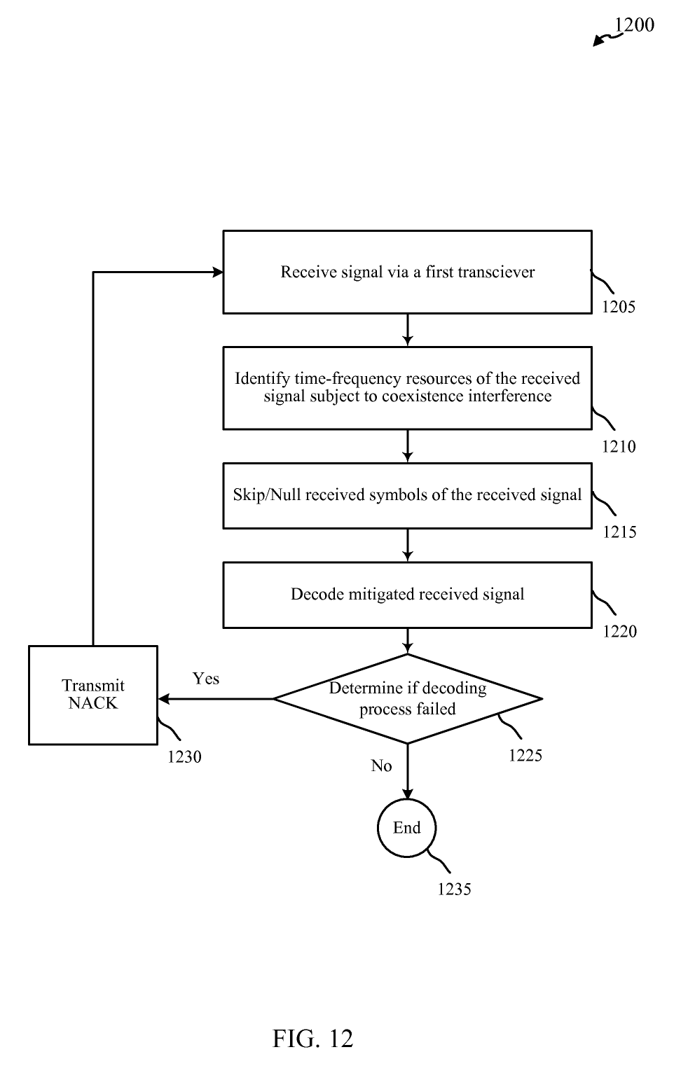

FIG. 12 is a flow chart illustrating another example of a method 1200 for applying resource-specific interference mitigation to identified time-frequency resources subject to in-device coexistence interference in accordance with various embodiments. For clarity, the method 1200 is described below with reference to one or more aspects of UEs 115 and/or devices 705 (or base stations 105) described with reference to the previous Figures. In some embodiments, a device such as one of the UEs 115 or devices 705 may execute one or more sets of codes to control the functional elements of the UE 115 or device 705 to perform the functions described below.

At block 1205, a device 705 (which may also refer to a UE 115) of the previous Figures, may receive a signal (e.g., an OFDM signal) via a first transceiver of the device 705. The received signal may experience coexistence interference from another transceiver of the device 705, for example, that is concurrently transmitting or receiving a message via another radio access technology.

At block 1210, the device 705 may identify time-frequency resources of the received signal subject to the coexistence interference. The identifying of the interfered time-frequency resources may be performed, for example by the transceiver 205, 510, 710/receiver 605 of the device 705, a coexistence manager 505 or a time-frequency resource identification module 715 of the device 705 as described above in reference to the previous Figures. The identifying may include comparing reference signals of the received transmission or obtaining information from the interfering transceiver via the coexistence manager 505 as described in reference to FIGS. 4 and 5.

At block 1215, the device 705 may skip or null one or more received symbols of the received signal that have been identified to have coexistence interference. Nulling one or more received symbols may include setting at least one of symbol period, a slot, a subframe, a code block, or a subcarrier of the received signal to a default value, or example zero. Nulling the interfered time-frequency resources may enable better error correction using parity bits, etc., of the received signal, for example and may generally improve the decoding process, as described in greater detail above. The skipped or nulled resources may then be input into the decoding operation at block 1220. In some implementations, a decoder 610 or decoding module 725, or resource-specific interference mitigation module 720 may perform the decoding operation at 1220.

At block 1225, the device 705 may determine if the decoding or soft combining process has failed. If the device 705 determines that the decoding has failed, the device may transmit a NACK at block 1230 to request retransmission by the sending device (e.g., base station 105). The method 1200 may then begin at block 1205 again and continue to repeat until the decoding process is determined to be successful at block 1230, at which time the method may terminate (e.g., by sending the decoded transport block or code blocks to a higher layer and sending an ACK signal, etc.) at 1235.

Thus, the method 1200 may provide for coexistence interference mitigation by nulling or skipping received interfered resources by a wireless device. It should be noted that the method 1200 is just one implementation and that the operations of the method 1200 may be rearranged or otherwise modified such that other implementations are possible.

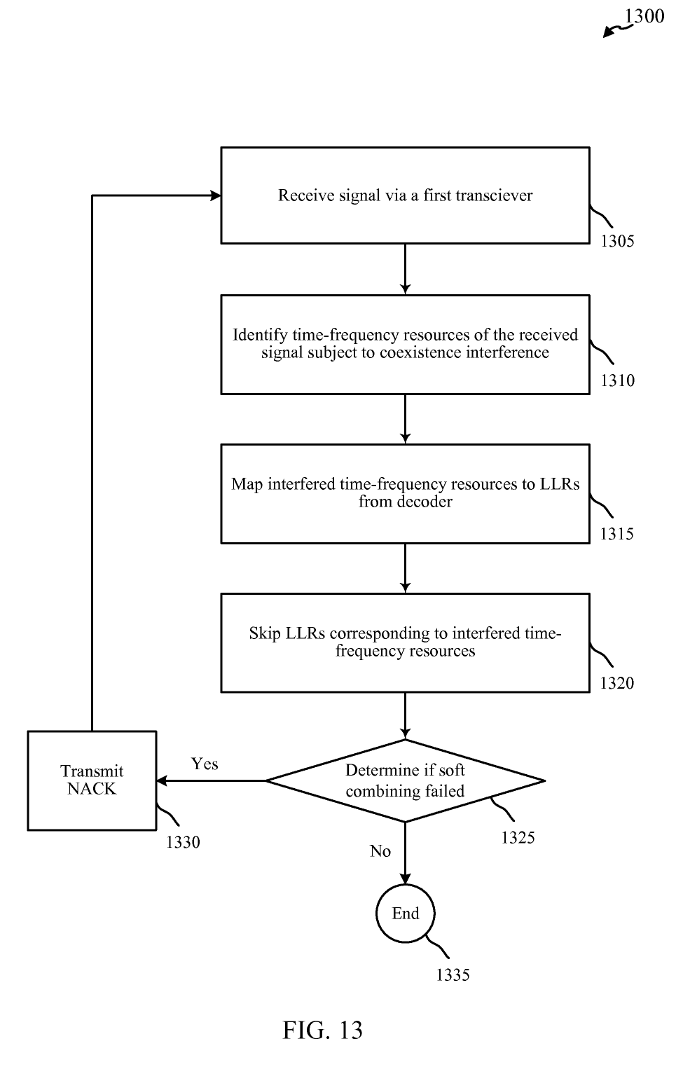

FIG. 13 is a flow chart illustrating another example of a method 1300 for applying resource-specific interference mitigation to identified time-frequency resources subject to in-device coexistence interference in accordance with various embodiments. For clarity, the method 1300 is described below with reference to one or more aspects of UEs 115 and/or devices 705 (or base stations 105) described with reference to the previous Figures. In some embodiments, a device such as one of the UEs 115 or devices 705 may execute one or more sets of codes to control the functional elements of the UE 115 or device 705 to perform the functions described below.

At block 1305, a device 705 (which may also refer to a UE 115) of the previous Figures, may receive a signal (e.g., an OFDM signal) via a first transceiver of the device 705. The received signal may experience coexistence interference from another transceiver of the device 705, for example, that is concurrently transmitting or receiving a message via another radio access technology.

At block 1310, the device 705 may identify time-frequency resources of the received signal subject to the coexistence interference. The identifying of the interfered time-frequency resources may be performed, for example by the transceiver 205, 510, 710/receiver 605 of the device 705, a coexistence manager 505 or a time-frequency resource identification module 715 of the device 705 as described above in reference to the previous Figures. The identifying may include comparing reference signals of the received transmission or obtaining information from the interfering transceiver via the coexistence manager 505 as described in reference to FIGS. 4 and 5.

At block 1315, the device 705 may map the interfered time-frequency resources to LLRs output from a decoder of the device 705. In some embodiments, the resource-specific interference mitigation module 720 may performing the mapping of LLRs received from a decoder 610/decoding module 725 described in reference to the previous Figures.

At block 1320, the device 705 may skip or null one or more LLRs corresponding (e.g., mapped) from the interfered time-frequency resources before sending the LLRs to a soft combining process, for example to soft combining/HARQ module 820 described in reference to FIG. 8. In this scenario, skipping interfered LLRs may reduce/eliminate error propagation in the decoding/soft combing process of the received signal. This may provide for better reception performance of the device 705 and may result in increased throughput.

At block 1325, the device 705 may determine if the soft combining process has failed. If the device 705 determines that the decoding has fails, the device may transmit a NACK at block 1330 to request retransmission by the sending device (e.g., base station 105). The method 1300 may then begin at block 1305 again and continue to repeat until the soft combining process is determined to be successful at block 1325, at which time the method may terminate at 1335 where the successfully decoded message or code blocks may be passed to higher layers and an ACK message may be generated.

Thus, the method 1300 may provide for coexistence interference mitigation by skipping LLRs corresponding to interfered resources by a wireless device. It should be noted that the method 1300 is just one implementation and that the operations of the method 1300 may be rearranged or otherwise modified such that other implementations are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method of wireless communication comprising:
receiving a signal via a first transceiver of a wireless device comprising multiple transceivers;
identifying interfered time-frequency resources, the interfered time-frequency resources being time-frequency resources of the received signal subject to coexistence interference; and
applying a resource-specific mitigation action for the received signal during a decoding operation of the received signal based at least in part on the interfered time-frequency resources.

2. The method of claim 1, wherein applying the resource-specific mitigation action comprises:
nulling samples of the received signal for at least a portion of a symbol period, a slot, a subframe, a code block, or a sub-carrier of the received signal; and
inputting the nulled samples into the decoding operation.

3. The method of claim 2, wherein nulling the received symbols of the received signal comprises setting the received symbols to a default value.

4. The method of claim 1, wherein applying the resource-specific mitigation action comprises:
skipping the decoding operation for samples of the received signal for at least a portion of a symbol period, a slot, a subframe, a code block, or a sub-carrier of the received signal.

5. The method of claim 1, wherein the interfered time-frequency resources are associated with a transmission from among a plurality of transmissions, wherein the plurality of transmissions are associated with a code block; and
wherein applying the resource-specific mitigation action comprises skipping decoding of the transmission during the decoding operation.

6. The method of claim 1, wherein the interfered time-frequency resources are associated with a transmission from among a plurality of transmissions, wherein the plurality of transmissions are associated with a code block; and
wherein applying the resource-specific mitigation action comprises skipping or nulling at least one log likelihood ratio (LLR) instance corresponding to a decoded output of the transmission during the decoding operation.

7. The method of claim 6, further comprising:
soft combining a plurality of sets of LLR instances from the plurality of transmissions during the decoding operation.

8. The method of claim 6, further comprising:
determining the at least one skipped or nulled LLR instance based on the interfered time-frequency resources.

9. The method of claim 1, wherein the first transceiver is associated with a first radio access technology, and wherein the coexistence interference originates from a second transceiver associated with a second radio access technology of the multiple transceivers.

10. The method of claim 9, wherein identifying the interfered time-frequency resources comprises:
receiving information associated with active transmissions or receptions from the second transceiver; and
determining a resource conflict for the interfered time-frequency resources based at least in part on the received information.

11. The method of claim 1, wherein identifying the interfered time-frequency resources comprises:
obtaining a first power level of a first cell specific reference (CRS) signal associated with the received signal and a second power level of a second CRS signal associated with the received signal;
comparing the first power level and the second power level; and
determining the interfered time-frequency resources based on the comparison of the first power level and the second power level.

12. An apparatus for wireless communication, comprising:
means for receiving a signal via a first transceiver of a wireless device comprising multiple transceivers;
means for identifying interfered time-frequency resources, the interfered time-frequency resources being time-frequency resources of the received signal subject to coexistence interference; and
means for applying a resource-specific mitigation action for the received signal during a decoding operation of the received signal based at least in part on the interfered time-frequency resources.

13. The apparatus of claim 12, wherein the means for applying the resource-specific mitigation action comprises:
means for nulling samples of the received signal for at least a portion of a symbol period, a slot, a subframe, a code block, or a subcarrier of the received signal; and
means for inputting the nulled samples into the decoding operation.

14. The apparatus of claim 12, wherein the means for applying the resource-specific mitigation action comprises:
means for skipping the decoding operation for samples of the received signal for at least a portion of a symbol period, a slot, a subframe, a code block, or a subcarrier of the received signal.

15. The apparatus of claim 12, wherein the interfered time-frequency resources are associated with a transmission from among a plurality of transmissions, wherein the plurality of transmissions are associated with a code block; and
wherein the means for applying the resource-specific mitigation action comprises means for skipping decoding of the transmission during the decoding operation.

16. The apparatus of claim 12, wherein the interfered time-frequency resources are associated with a transmission from among a plurality of transmissions, wherein the plurality of transmissions are associated with a code block; and
wherein the means for applying the resource-specific mitigation action comprises means for skipping or nulling at least one log likelihood ratio (LLR) instance corresponding to a decoded output of the transmission during the decoding operation.

17. The apparatus of claim 12, wherein the first transceiver is associated with a first radio access technology;
wherein the coexistence interference originates from a second transceiver associated with a second radio access technology of the multiple transceivers; and
wherein the means for identifying the interfered time-frequency resources comprises:
means for receiving information associated with active transmissions or receptions from the second transceiver; and
means for determining a resource conflict for the interfered time-frequency resources based at least in part on the received information.

18. The apparatus of claim 12, wherein the means for identifying the interfered time-frequency resources comprises:
means for obtaining a first power level of a first cell specific reference (CRS) signal associated with the received signal and a second power level of a second CRS signal associated with the received signal;
means for comparing the first power level and the second power level; and
means for determining the interfered time-frequency resources based on the comparison of the first power level and the second power level.

19. A wireless communications device, comprising:
a memory; and
at least one processor coupled to the memory, and configured to:
receive a signal via a first transceiver of a wireless device comprising multiple transceivers;
identify interfered time-frequency resources, the interfered time-frequency resources being time-frequency resources of the received signal subject to coexistence interference; and
apply a resource-specific mitigation action for the received signal during a decoding operation of the received signal based at least in part on the interfered time-frequency resources.

20. The wireless communications device of claim 19, wherein the processor is further configured to:
null samples of the received signal for at least a portion of a symbol period, a slot, a subframe, a code block, or a subcarrier of the received signal; and
input the nulled samples into the decoding operation.

21. The wireless communications device of claim 19, wherein the processor is further configured to:
skip the decoding operation for samples of the received signal for at least a portion of a symbol period, a slot, a subframe, a code block, or a subcarrier of the received signal.

22. The wireless communications device of claim 19, wherein the interfered time-frequency resources are associated with a transmission from among a plurality of transmissions, wherein the plurality of transmissions are associated with a code block; and wherein the processor is further configured to skip decoding of the transmission during the decoding operation.

23. The wireless communications device of claim 19, wherein the interfered time-frequency resources are associated with a transmission from among a plurality of transmissions, wherein the plurality of transmissions are associated with a code block; and
wherein the processor is further configured to skip or null at least one log likelihood ratio (LLR) instance corresponding to a decoded output of the transmission during the decoding operation.

24. The wireless communications device of claim 19, wherein the first transceiver is associated with a first radio access technology;
wherein the coexistence interference originates from a second transceiver associated with a second radio access technology of the multiple transceivers; and
wherein the processor is further configured to:
receive information associated with active transmissions or receptions from the second transceiver; and
determine a resource conflict for the interfered time-frequency resources based at least in part on the received information.

25. The wireless communications device of claim 19, wherein the processor is further configured to:
obtain a first power level of a first cell specific reference (CRS) signal associated with the received signal and a second power level of a second CRS signal associated with the received signal;
compare the first power level and the second power level; and
determine the interfered time-frequency resources based on the comparison of the first power level and the second power level.

26. A computer program product operable on a wireless communications device, stored on a non-transitory computer-readable medium, and comprising instructions executable by a processor to:
receive a signal via a first transceiver of a wireless device comprising multiple transceivers;
identify interfered time-frequency resources, the interfered time-frequency resources being time-frequency resources of the received signal subject to coexistence interference; and
apply a resource-specific mitigation action for the received signal during a decoding operation of the received signal based at least in part on the interfered time-frequency resources.

27. The computer program product of claim 26, wherein the instructions are executable by the processor to:
null samples of the received signal for at least a portion of a symbol period, a slot, a subframe, a code block, or a subcarrier of the received signal; and
input the nulled samples into the decoding operation.

28. The computer program product of claim 26, wherein the instructions are executable by the processor to:
skip the decoding operation for samples of the received signal for at least a portion of a symbol period, a slot, a subframe, a code block, or a subcarrier of the received signal.

29. The computer program product of claim 26, wherein the interfered time-frequency resources are associated with a transmission from among a plurality of transmissions, wherein the plurality of transmissions are associated with a code block, and wherein the instructions are executable by the processor to:
skip decoding of the transmission during the decoding operation.

30. The computer program product of claim 26, wherein the interfered time-frequency resources are associated with a transmission from among a plurality of transmissions, wherein the plurality of transmissions are associated with a code block, and wherein the instructions are executable by the processor to:
skip or null at least one log likelihood ratio (LLR) instance corresponding to a decoded output of the transmission during the decoding operation.
